(19) United States
(12) Patent Application Publication
(10) Pub. No.: US 2025/0096344 A1
(43) Pub. Date: Mar. 20, 2025

(54) SYSTEM AND METHOD FOR RECOVERING METAL FROM BATTERY MATERIALS

(71) Applicant: LI-CYCLE CORP., Toronto (CA)

(72) Inventors: Christopher James BIEDERMAN, Hannon (CA); Darcy Lionel TAIT, Uxbridge (CA); Timothy George JOHNSTON, Toronto (CA); Muhammad HAZIQ UDDIN, Mississauga (CA)

(73) Assignee: LI-CYCLE CORP., Toronto, ON (CA)

(21) Appl. No.: 18/292,209

(22) PCT Filed: Aug. 2, 2022
(86) PCT No.: PCT/CA2022/051176

§ 371 Date: Jan. 25, 2024

Related U.S. Application Data
(60) Provisional application No. 63/228,733, filed on Aug. 3, 2021.

(51) Int. Cl. H01M 10/54; C01F 7/02; C22B 1/24; C22B 3/22; C22B 7/00; C22B 15/00; C22B 21/00

(52) U.S. Cl. CPC H01M 10/54; C01F 7/02; C22B 1/24; C22B 3/22; C22B 7/005; C22B 7/008; C22B 15/008; C22B 21/0023

(57) ABSTRACT

A method of processing size-reduced battery materials comprising aluminum, copper and black mass, may include: subjecting the size-reduced battery materials to a caustic leaching process to yield a pregnant leach solution; physically separating the pregnant leach solution into oversized solids and a screened leach stream, the oversized solids being rich in copper; and filtering the screened leach stream to yield a filter cake that is rich in black mass, and a filtered leach stream that is rich in aluminum.

### FIELD OF THE INVENTION

In one of its aspects, the present disclosure relates generally to a system and method for processing batteries, including lithium-ion batteries (ternary, Lithium Iron Phosphorous batteries “LFP”, lithium solid state batteries “SSB” and the like) and other suitable batteries, and more particularly to systems and methods for recycling lithium-ion and the recovering of at least some lithium and/or other target metals, such as copper and aluminum, therefrom.

### INTRODUCTION

U.S. Pat. No. 9,312,581 relates to a method for recycling lithium batteries and more particularly batteries of the Li-ion type and the electrodes of such batteries. This method for recycling lithium battery electrodes and/or lithium batteries comprises the following steps: a) grinding of said electrodes and/or of said batteries, b) dissolving the organic and/or polymeric components of said electrodes and/or of said batteries in an organic solvent, c) separating the undissolved metals present in the suspension obtained in step b), d) filtering the suspension obtained in step c) through a filter press, e) recovering the solid mass retained on the filter press in step d), and suspending this solid mass in water, f) recovering the material that sedimented or coagulated in step e), resuspending this sedimented material in water and adjusting the pH of the suspension obtained to a pH below 5, preferably below 4, g) filtering the suspension obtained in step f) on a filter press, and h) separating, on the one hand, the iron by precipitation of iron phosphates, and on the other hand the lithium by precipitation of a lithium salt. The method of the invention finds application in the field of recycling of used batteries, in particular.

International Patent Application No. WO2005/101564 a method for treating all types of lithium anode batteries and cells via a hydrometallurgical process at room temperature. Said method is used to treat, under safe conditions, cells and batteries including a metallic lithium anode or an anode containing lithium incorporated in an anode inclusion compound, whereby the metallic casings, the electrode contacts, the cathode metal oxides and the lithium salts can be separated and recovered.

US Patent Publication No. 2010/0230518 discloses a method of recycling sealed batteries, the batteries are shredded to form a shredded feedstock. The shredded feedstock is heated above ambient temperature and rolled to form a dried material. The dried material is screen separating into a coarse fraction and a powder fraction and the powder fraction is output. A system for recycling sealed cell batteries comprises an oven with a first conveyor extending into the oven. A rotatable tunnel extends within the oven from an output of the first conveyor. The tunnel has a spiral vane depending from its inner surface which extends along a length of the tunnel. A second conveyor is positioned below an output of the rotatable tunnel.

U.S. Pat. No. 8,858,677 discloses a valuable-substance recovery method according to the present invention includes: a solvent peeling step (S3) of dissolving a resin binder included in an electrode material by immersing crushed pieces of a lithium secondary battery into a solvent, so as to peel off the electrode material containing valuable substances from a metal foil constituting the electrode; a filtering step (S4) of filtering a suspension of the solvent, so as to separate and recover the electrode material containing the valuable substances and a carbon material; a heat treatment step (S5) of heating the recovered electrode material containing the valuable substances and the carbon material, under an oxidative atmosphere, so as to burn and remove the carbon material; and a reducing reaction step (S6) of immersing the resultant electrode material containing the valuable substances into a molten salt of lithium chloride containing metal lithium, so as to perform a reducing reaction.

PCT patent publication no. WO2018/218358 discloses a process to recover materials from rechargeable lithium-ion batteries, thus recycling them. The process involves processing the batteries into a size-reduced feed stream; and then, via a series of separation, isolation, and/or leaching steps, allows for recovery of a copper product, cobalt, nickel, and/or manganese product, and a lithium product; and, optional recovery of a ferrous product, aluminum product, graphite product, etc. An apparatus and system for carrying out size reduction of batteries under immersion conditions is also provided.

### SUMMARY

Lithium-ion rechargeable batteries are increasingly powering automotive, consumer electronic, and industrial energy storage applications. An estimated 11+million tonnes of spent lithium-ion battery packs are expected to be discarded between 2017 and 2030, driven by application of lithium-ion batteries in electro-mobility applications such as electric vehicles.

Rechargeable lithium-ion batteries, including ternary, LFP, SSBs, and other types of batteries that may be processed using the teachings here, comprise a number of different materials within their battery cells.

A portion of the lithium-ion batteries can be described as ternary batteries, which can include lithium batteries that use lithium nickel cobalt manganate as the cathode and graphite as the anode. Other portions of the lithium-ion batteries can include lithium iron phosphate (LFP, or sometimes as a lithium ferrophosphate battery) batteries and these batteries may have a different composition than other types of lithium-ion batteries. For example, LFP batteries utilize LiFePO₄ as a cathode material, usually in combination with a graphitic carbon-based anode. LFP batteries typically include relatively lower amounts of metals, such as nickel and cobalt, than other types of lithium-ion batteries. As nickel and cobalt can be relatively valuable, the relatively low amounts of these metals in LFP batteries may make LFP batteries less desirable to recycle than other forms of batteries that would yield relatively larger amounts of these valuable metals.

Lithium-ion batteries are a type of rechargeable battery in which lithium ions drive an electrochemical reaction. Lithium has a high electrochemical potential and a high energy density. Lithium-ion battery cells have four key components: a. Positive electrode/cathode: including differing formulations of metal oxides or metal phosphate depending on battery application and manufacturer, intercalated on a cathode backing foil/current collector (e.g. aluminum)—for example: LiNixMnyCOzO2 (NMC); LiCoO2 (LCO); LiFePO4 (LFP); LiMn2O4 (LMO); LiNiCoAlO2 (NCA); b. Negative electrode/anode: generally, comprises graphite intercalated on an anode backing foil/current collector (e.g. copper); c. Electrolyte: for example, lithium hexafluorophosphate (LiPF6), lithium tetrafluoroborate (LiBF4), lithium perchlorate (LiClO4), lithium hexafluoroarsenate monohydrate (LiAsF6), lithium trifluoromethanesulfonate (LiCF3SO3), lithium bis(bistrifluoromethanesulphonyl) (LiC₂F₆NO₄S₂), lithium organoborates, or lithium fluoroalkylphosphates dissolved in an organic solvent (e.g., mixtures of alkyi carbonates, e.g. Ci-C6 alkyl carbonates such as ethylene carbonate (EC, generally required as part of the mixture for sufficient negative electrode/anode passivation), ethyl methyl carbonate (EMC), dimethyl carbonate (DMC), diethyl carbonate (DEC), propylene carbonate (PC)); and d. Separator between the cathode and anode: for example, polymer or ceramic based.

“Black mass” as used herein refers to a combination of some of the components of rechargeable lithium-ion batteries (and/or other batteries) that can be liberated from within the cell during a processing step (such as a mechanical processing, disassembly and/or comminuting step) and includes at least a combination of cathode and/or anode electrode powders that may include lithium, nickel, cobalt, iron, phosphorous, manganese metal oxides. Materials present in rechargeable lithium-ion batteries include anode and cathode materials, as well as a suitable electrolyte (residual organic electrolyte such as Ci-C6 alkyl carbonates, such as ethylene carbonate (EC), ethyl methyl carbonate (EMC), dimethyl carbonate (DMC), diethyl carbonate (DEC), propylene carbonate (PC), and mixtures thereof) and possibly a solid separator which may be sulfide, oxide, ceramic or glass for SSBs. Depending on the type of batteries, or mixture of types of batteries that are being processed then the metals included in the black mass may be expected to include lithium, nickel, cobalt, iron, phosphorous, manganese.

Large format lithium-ion battery packs (e.g. in automotive and stationary energy storage system applications) are generally structured as follows: a. Cells: cells contain the cathode, anode, electrolyte, separator, housed in steel, iron, aluminum, and/or plastic; b. Modules: multiple cells make up a module, typically housed in steel, aluminum, and/or plastic; and c. Battery pack: multiple modules make up a battery pack, typically housed in steel, aluminum, and/or plastic.

Several of the materials in a lithium-ion battery or battery pack can be recycled and may form separate outputs from an overall battery recycling process. For example, as noted above, PCT patent publication no. WO2018/218358 discloses a process to recover materials from rechargeable lithium-ion batteries, thus recycling them. The process involves processing the batteries into a size-reduced feed stream; and then, via a series of separation, isolation, and/or leaching steps, allows for recovery of a copper product, cobalt, nickel, and/or manganese product, and a lithium product; and, optional recovery of a ferrous product, aluminum product, graphite product, etc. An apparatus and system for carrying out size reduction of batteries under immersion conditions is also provided. However, while shredding the incoming battery materials under immersion conditions, such as described in PCT patent publication no. WO2018/218358, can have some benefits there can also be some challenges in processing the battery materials using this method.

Therefore, there remains a need for an improved system and/or process for extracting target metals or target shred materials that are liberated from the battery materials during the size reduction process, such that these target shred materials can be collected and sold or sent for further processing while other components of the battery materials, including plastic by-products and at least a majority of the black mass material can be separated from the target shred materials for further processing. When conducting a size reduction on the types of batteries described herein, the target shred materials may include a mixture of different metals, including copper, steel, iron and aluminum, and may also include some relatively high density plastic material (such that it tends to be collected with the metal flakes rather than the lighter plastic materials) and a relatively small amount of retained black mass material that is mixed with the target shred metal mixture. While described as a metal “shred” materials for convenience, the materials described herein do not need to be “shredded” but can be the result of any suitable size reduction technique, including cutting, grinding or other physical disassembly techniques. That is, materials that are “cut” apart can still be considered to be target shred materials for the purposes of the teachings herein.

To help address at least one of these shortcomings in the art, an improved method for processing the target shred materials that are obtained by conducting a size reduction process on incoming battery materials.

In accordance with one broad aspect of the teachings described herein, a system for processing size-reduced battery materials comprising aluminum, copper and black mass, can include a caustic leaching apparatus configured to leach the size-reduced battery materials and dissolve the aluminum contained in the size-reduced battery materials thereby yielding a pregnant leach solution. A first solid liquid separation apparatus may be downstream from the caustic leaching apparatus and may be configured to physically separate a solid, upgraded shred product from the pregnant leach solution thereby producing a screened leach stream, the upgraded shred product comprising solid copper material and having a higher concentration of copper and a lower concentration of aluminum than the screened leach stream. A second solid liquid separation apparatus may be downstream from the first solid liquid separation apparatus and may be configured to separate at least a portion of the black mass from the screened leach stream thereby providing an aluminum rich leach stream that comprises at least a majority of the aluminum from the size-reduced battery materials and is substantially depleted of black mass and copper.

The second solid liquid separator may include a filter apparatus configured to filter the screened leach stream to yield a filter cake that comprises the black mass separated from the aluminum rich leach stream.

An aluminum separation apparatus may be downstream from the second solid liquid separation apparatus and may be configured to separate an aluminum product material from the aluminum rich leach stream and optionally wherein the wherein the aluminum product material comprises at least one of aluminum hydroxide and aluminum oxide.

The aluminum separation apparatus may include a crystallization apparatus configured to subject the aluminum rich leach stream to a crystallization process, thereby yielding a caustic crystallization slurry comprising crystalline solids that contain the aluminum product material.

The aluminum product material in the crystalline solids may include one or more of aluminum hydroxide and aluminum trihydroxide. Downstream from the crystallization apparatus may be a drying apparatus oven that is configured to dry the crystalline solids that contain the aluminum product material into a dried crystalline solid comprising aluminum. A calcinating apparatus may be downstream from the drying apparatus to calcine the dried crystalline solid comprising aluminum into an aluminum oxide product.

A third solid-liquid separation apparatus may be configured to filter the caustic crystallization slurry to separate out the crystalline solids, and thereby yield a caustic leach recycle stream.

At least a portion of the crystalline solids may be returned to the crystallization apparatus as crystallization seeds used in the crystallization process.

A particle size reduction apparatus may be downstream from the third solid-liquid separator and may be configured to reduce a particle size of the crystalline solids to yield reduced size crystalline solids. The reduced size crystalline solids may be returned to the crystallization apparatus as the crystallization seeds.

A particle size reduction apparatus may be downstream from the third solid-liquid separator and may be configured to reduce a particle size of the crystalline solids and produce reduced size crystalline solids and disperse at least a portion of the reduced size crystalline solids in a portion the caustic leach recycle stream, to yield a reduced particle size slurry. The reduced particle size slurry may be returned to the crystallization apparatus to provide the crystallization seeds.

A first particle size reduction apparatus may be downstream from the third solid-liquid separator and may be configured to reduce a particle size of the crystalline solids to yield reduced size crystalline solids. A second particle size reduction apparatus may be disposed downstream from the first particle size reduction apparatus and may be configured receive the reduced size crystalline solids and to further reduce a particle size of the reduced size crystalline solids, once redispersed in a portion the caustic leach recycle stream, to yield a reduced particle size slurry. The reduced particle size slurry may be returned to the crystallization apparatus to provide the crystallization seeds.

The aluminum separation apparatus may be configured so that at least a portion of the caustic leach recycle stream is directed to the caustic leaching apparatus whereby it is returned to the caustic leaching process.

The aluminum separation apparatus may be configured to extract a slip stream that comprises a portion of the caustic leach recycle stream between the and the caustic leaching apparatus and the third solid-liquid separator and prior to the caustic leach recycle stream being returned to the caustic leaching apparatus, thereby reducing an amount of the caustic leach recycle stream that reaches the caustic leach apparatus and inhibiting an accumulation of impurities introduced into the caustic leaching apparatus via the caustic leach recycle stream.

The impurities in the caustic leach recycle stream may include one or more of organic compounds and alcohols.

The slip stream may include between about 10% to about 50% of the volume of the caustic leach recycle stream, preferably between about 15% to about 45%, more preferably between about 20% to about 40%, still more preferably between about 25% to about 35%, and most preferably between about 30% of the caustic leach recycle stream

Upstream from the third solid-liquid separation apparatus there may be a crystal size classification apparatus configured to separate out oversized crystalline solids, and thereby yield a screened caustic crystallization slurry comprising undersized crystalline solids. The screened caustic crystallization slurry may be fed into the solid-liquid separation apparatus as the caustic crystallization slurry.

The crystal size classification apparatus may include one or more of a counter current settling apparatus and a hydrocyclone apparatus.

The undersized crystalline solids may be returned to the crystallization apparatus as crystallization seeds.

A second caustic leaching apparatus may be configured to leach the filter cake to yield a secondary pregnant leach solution. A second filter apparatus may be configured to filter the secondary pregnant leach solution to yield a refined filter cake that is rich in black mass and a secondary aluminum rich leach stream, the refined filter cake having a lower aluminum concentration than the filter cake.

A crystallization apparatus may be downstream from the second solid liquid separation apparatus and may be configured to subject the aluminum rich leach stream to a crystallization process, to yield a caustic crystallization slurry comprising crystalline solids. A fourth solid-liquid separation apparatus may be configured to filter the caustic crystallization slurry to separate out the crystalline solids, and thereby yield a caustic leach recycle stream. The caustic leach recycle stream may be fed into the second caustic leaching apparatus.

The secondary aluminum rich leach stream may be returned to the caustic leaching process.

The size-reduced battery materials may have a first aluminum concentration, a first copper concentration, and a first black mass concentration and the oversized solids may have a second copper concentration that is higher than the first copper concentration. The filter cake may have a second black mass concentration that is higher than the first black mass concentration.

The caustic leaching apparatus may include a caustic leaching solution having a pH that is greater than 9.

The caustic leaching solution pH may be greater than 10, more preferably greater than 11, still more preferably greater than 12, still more preferably greater than 13, and most preferably 14 or higher.

The caustic leaching solution may have a NaOH concentration of between about 1 to about 10 M, preferably from about 2 to about 8 M, more preferably from about 3 to about 7 M, still more preferably from about 4 to about 6 M, and most preferably about 5 M.

The caustic leaching apparatus may be configured so that the caustic leaching solution at an operating pressure that is between 0.8 to 1.2 times atmospheric pressure, preferably 0.85 to 1.15 times atmospheric pressure, more preferably 0.9 to 1.1 times atmospheric pressure, still more preferably 0.95 to 1.05 times atmospheric pressure. The operating pressure may be about atmospheric pressure.

The caustic leaching apparatus may be configured so that the caustic leaching solution at a temperature that is between 0.7 times its boiling point at the operating pressure and its boiling point at the operating pressure, preferably between 0.8 and 0.99 times, more preferably between 0.85 and 0.97 times, still more preferably between 0.88 and 0.95 times, still more preferably between 0.90 and 0.93 times, and most preferably about 0.92 times its boiling point at the operating pressure.

The caustic leaching solution may be held at a temperature of about 75, 80, 85, 90, 95, 100 or 105° C.

A titration unit may be configured to control a caustic concentration of the caustic leaching solution.

The first solid liquid separation apparatus may include a screen or a sieve.

The first solid liquid apparatus has openings configured to catch solid particles that are about 500 μm in size or larger.

A washing apparatus may be configured to rinse the upgraded shred product with a washing liquid to remove residual caustic leaching solution from the upgraded shred product.

The second solid liquid separation apparatus may include a washing apparatus configured to rinse the filter cake with a washing liquid to remove residual caustic leaching solution from the filter cake.

A size reduction apparatus may be upstream from the first solid liquid separation apparatus and may be configured to receive battery materials and to generate the size-reduced battery materials. The size reduction apparatus may include an immersion comminuting apparatus having a housing containing an immersion liquid, at least one battery inlet through which the battery materials can be introduced into the housing, at least a first, submergible comminuting device disposed within the housing submerged in the immersion liquid and configured to cause a primary size reduction of the battery materials and release the copper, aluminum and black mass materials from within the battery materials to form reduced-size battery materials.

A ferrous separator apparatus may be disposed between the size reduction apparatus upstream from the first solid liquid separation apparatus configured to remove at least some ferromagnetic material from the size-reduced battery materials exiting the size reduction apparatus before the size-reduced battery materials enter the caustic leaching apparatus.

The ferrous separator apparatus may include a magnetic separation apparatus.

In accordance with another broad aspect of the teachings described herein, a method of processing size-reduced battery materials comprising aluminum, copper and black mass may include the steps of; leaching the size-reduced battery materials using a caustic leaching apparatus containing a caustic leach solution to yield a pregnant leach solution; separating a solid, upgraded shred product comprising solid copper material from the pregnant leach solution using a first solid liquid separation apparatus thereby producing a screened leach stream having a lower concentration of copper and a higher concentration of aluminum than upgraded shred product; and separating at least a portion of the black mass material from the screened leach stream using a second solid liquid separator and obtaining an aluminum rich leach stream that comprises at least a majority of the aluminum from the size-reduced battery materials and is substantially depleted of at least one of black mass and copper.

The second solid liquid separator may include a filter and separating at least a portion of the black mass material from the screened leach stream may include collecting a filter cake that comprises the black mass separated from the aluminum rich leach stream using the filter.

The method may include separating an aluminum product material, that comprises optionally at least one of aluminum hydroxide and aluminum oxide, and a caustic product from the aluminum rich leach stream using an aluminum separation apparatus.

The method may include subjecting the aluminum rich leach stream to a crystallization process to yield a caustic crystallization slurry comprising crystalline solids.

The crystalline solids may include one or more of aluminum hydroxide and aluminum trihydroxide.

The method may include separating the crystalline solids from the caustic crystallization slurry using a solid-liquid separation process to provide a caustic leach recycle stream.

The method may include returning at least a portion of the crystalline solids to the crystallization apparatus as crystallization seeds.

The method may include reducing a particle size of the crystalline solids to yield reduced size crystalline solids; and returning the reduced size crystalline solids to the crystallization apparatus as the crystallization seeds.

The method may include redispersing the crystalline solids in a portion of the caustic leach recycle stream; reducing a particle size of the redispersed crystalline solids to yield a reduced particle size slurry; and returning the reduced particle size slurry to the crystallization apparatus to provide the crystallization seeds.

The method may include reducing a particle size of the crystalline solids to yield reduced size crystalline solids; redispersing the reduced size crystalline solids in a portion the caustic leach recycle stream; further reducing a particle size of the redispersed the reduced size crystalline solids to yield a reduced particle size slurry; and returning the reduced particle size slurry to the crystallization apparatus to provide the crystallization seeds.

The method may include recycling at least a portion of the caustic leach recycle stream to the caustic leaching process.

The method may include removing a portion of the caustic leach recycle stream, before returning the caustic leach recycle stream to the caustic leaching apparatus, as a slip stream, thereby reducing the introduction of impurities contained in the caustic leach recycle stream into the caustic leaching apparatus.

The impurities may include one or more of organic compounds and alcohols.

The slip stream may be formed by removing about 10% to about 50% of the caustic leach recycle stream, preferably about 15% to about 45%, more preferably about 20% to about 40%, still more preferably about 25% to about 35%, and most preferably about 30% of the caustic leach recycle stream

The method may include, prior to separating the crystalline solids from the caustic crystallization slurry separating oversized crystalline solids from the caustic crystallization slurry thereby yielding a screened caustic crystallization slurry comprising undersized crystalline solids; and feeding the screened caustic crystallization slurry into the solid-liquid separation apparatus as the caustic crystallization slurry.

Separating the oversized crystalline solids from the caustic crystallization slurry may include utilizing one or more of a counter current settling apparatus and a hydrocyclone separation.

The method may include returning at least a portion of the crystalline solids to the crystallization apparatus as crystallization seeds.

The method may include subjecting the filter cake to a second caustic leaching process to yield a secondary pregnant leach solution; and secondary filtering the secondary pregnant leach solution to yield a refined filter cake that is rich in black mass and a secondary aluminum rich leach stream, the refined filter cake having a lower aluminum concentration than the filter cake.

The method may include subjecting the aluminum rich leach stream to a crystallization process to yield a caustic crystallization slurry comprising crystalline solids; subjecting the caustic crystallization slurry to a solid-liquid separation process to separate out the crystalline solids, and thereby yield a caustic leach recycle stream; and feeding the caustic leach recycle stream into the second caustic leaching apparatus.

The method may include returning at least a portion of the secondary aluminum rich leach stream to the caustic leaching apparatus.

The size-reduced battery materials may include aluminum at a first aluminum concentration, copper at a first copper concentration, and black mass at a first black mass concentration, The upgraded shred product may have a second copper concentration that is higher than the first copper concentration. The black mass material may have a second black mass concentration that is higher than the first black mass concentration.

The caustic leaching process may utilize a caustic leaching solution having a pH that is greater than 9.

The caustic leaching solution may have a pH that is greater than 10, more preferably greater than 11, still more preferably greater than 12, still more preferably greater than 13, and most preferably 14 or higher.

The caustic leaching solution may have a NaOH concentration of between about 1 to about 10 M, preferably from about 2 to about 8 M, more preferably from about 3 to about 7 M, still more preferably from about 4 to about 6 M, and most preferably about 5 M.

The method may include maintaining the caustic leaching solution at an operating pressure of 0.8 to 1.2 times atmospheric pressure, preferably 0.85 to 1.15 times atmospheric pressure, more preferably 0.9 to 1.1 times atmospheric pressure, still more preferably 0.95 to 1.05 times atmospheric pressure.

The operating pressure may be about atmospheric pressure.

The method may include inhibiting boiling of the caustic leaching solution by maintaining the caustic leaching solution at a temperature that between 0.7 times its boiling point and its boiling point at the operating pressure, preferably between 0.8 and 0.99 times, more preferably between 0.85 and 0.97 times, still more preferably between 0.88 and 0.95 times, still more preferably between 0.90 and 0.93 times, and most preferably about 0.92 times its boiling point at the operating pressure.

The caustic leaching solution may be at a temperature of about 75, 80, 85, 90, 95, 100 or 105° C.

The method may include controlling a caustic concentration of the caustic leaching solution.

Separating the upgraded shred product from the pregnant leach solution using the first solid liquid separation apparatus may include using a screen or a sieve.

The screen or the sieve ay have openings of about 500 μm in size.

The method may include rinsing the upgraded shred product with a washing liquid to recover residual caustic leaching solution from the upgraded shred products.

The method may include rinsing the filter cake with a washing liquid to recover residual caustic leaching solution from the filter cake.

The method may include, prior to leaching the size-reduced battery materials, subjecting battery materials to a size reduction process under immersion conditions using a size reduction apparatus comprising an immersion comminuting apparatus having a housing containing an immersion liquid, at least one battery inlet through which the battery materials can be introduced into the housing, at least a first, submergible comminuting device disposed within the housing submerged in the immersion liquid and configured to cause a primary size reduction of the battery materials and release the copper, aluminum and black mass materials from within the battery materials to form reduced-size battery materials.

The method may include, prior to the caustic leaching process, removing at least some ferromagnetic material from the size-reduced battery materials using a ferrous separator.

The ferrous separator may include a magnetic separator.

In accordance with another broad aspect of the teachings described herein, a system for processing size-reduced battery materials comprising aluminum, copper and black mass may include a caustic leaching apparatus configured to leach the shredded battery materials using a caustic leach solution. Downstream from the caustic leaching apparatus there may be a first solid liquid separation apparatus configured to separate a shred product comprising at least the copper from the size-reduced battery materials by mechanical separation; a second solid liquid separation apparatus configured to separate a target shred material comprising at least the black mass material from the size-reduced battery materials; and an aluminum separation apparatus configured to separate a solid comprising aluminum from the size-reduced battery materials.

Upstream from the caustic leaching apparatus there may be a ferrous separator apparatus configured to separate a ferromagnetic product from a mixture comprising the shredded battery materials.

The caustic leach solution may be an aqueous solution comprising one or more of sodium hydroxide and potassium hydroxide.

The caustic leach solution may have a pH of 13 or higher.

The caustic leach solution may have a molarity of between about 1 and about 7 M.

The caustic leach solution may be held at a temperature of about 100° C. The caustic leach solution may be at atmospheric pressure.

The caustic leaching apparatus may be configured to output a pregnant leach stream, the pregnant leach stream comprising an aqueous aluminum-containing solution.

A titration unit may be configured to control a concentration of the caustic leach solution within the caustic leaching apparatus.

The caustic leaching apparatus may be configured to carry out a batch process and is configured to leach the shredded battery materials for a period of between 15 minutes and 12 hours.

The first solid liquid separation apparatus may be immediately downstream from the caustic leaching apparatus.

The first solid liquid separation apparatus may include a screen or sieve.

The screen or sieve may have openings of about 500 μm in size.

The first solid liquid separation apparatus may include a washing apparatus configured to rinse the shred product with water, for recovery of residual caustic leach solution from the shred product.

The shred product may have a higher copper content than each of the target shred material and the solid comprising aluminum.

The second solid liquid separation apparatus may be downstream from the first solid liquid separation apparatus.

The second solid liquid separation apparatus may include a filter press having a filter with openings of about 200 μm in size.

The second solid liquid separation apparatus ay be configured to separate out the target shred material in form of a filter cake.

An additional washing apparatus may be configured to rinse the filter cake with a wash liquid, for recovery of residual caustic leach solution from the filter cake.

The aluminum separation apparatus may include a crystallization apparatus that is downstream from the second solid liquid separation apparatus.

The aluminum separation apparatus may include a crystallization apparatus that is configured to receive an aluminum rich leach stream output from the second solid liquid separation apparatus, to cool the aluminum rich leach stream during a crystallization period, and to nucleate crystals of the solid comprising aluminum during the crystallization period.

The crystallization apparatus may be configured to run a batch process, and the crystallization period is between about 6 hours and about 72 hours.

The crystallization apparatus may be configured to run a continuous process.

The solid comprising aluminum may include one or more of aluminum hydroxide and aluminum trihydroxide.

The system may include downstream from the crystallization apparatus, a crystal size classification apparatus configured to separate crystals of the solid comprising aluminum from liquor output from the crystallization apparatus, according to size of the crystals.

The crystal size classification apparatus may include one or more of a counter current settling apparatus and a hydrocyclone apparatus.

Downstream from the crystallization apparatus there may be an oven configured to dry crystals of the solid comprising aluminum into a dried crystalline solid comprising aluminum.

Downstream from the oven, there may be a kiln or a furnace configured to calcine the dried crystalline solid comprising aluminum into an aluminum oxide product.

Downstream from the crystallization apparatus there may be a solid-liquid separation apparatus configured to separate aluminum hydroxide solids from liquid by filtering.

The aluminum-containing solids may be sized to serve as seeds for nucleating crystals of the solid comprising aluminum, when the aluminum hydroxide solids are added into the crystallization apparatus.

A filtrate from the aluminum solid filter press may be configured to be returned to the caustic leaching apparatus as a caustic leach recycle stream.

A slip stream may include a portion of the caustic leach recycle stream prior to being returned to the caustic leaching apparatus, for reducing accumulation of impurities in the system.

The impurities may include one or more of organic compounds and alcohols.

A second caustic leaching apparatus may be configured to leach the separated target shred material using a second caustic leach solution.

A filtrate of the aluminum solid filter press may be configured to be fed into the second caustic leaching apparatus as at least a portion of the second caustic leach solution.

In accordance with another broad aspect of the teachings described herein, a method of processing shredded battery materials to extract a target shred material, may include the steps of; subjecting the shredded battery materials to a caustic leaching process to yield a pregnant leach solution; screening the pregnant leach solution to separate out large solids, and to provide a screened leach stream; filtering the screened leach stream to yield a filter cake comprising the target shred material, and an aluminum rich leach stream; subjecting the aluminum rich leach stream to a crystallization process to yield a caustic crystallization slurry comprising solid crystals; and filtering the caustic crystallization slurry to separate out solids, and thereby yield a caustic leach recycle stream.

The method may include returning the solids to the crystallization process as seeds.

The method may include returning the caustic leach recycle stream to the caustic leaching process.

The method may include, prior to filtering the caustic crystallization slurry: subjecting the caustic crystallization slurry to a crystal size classification process to separate out oversized solids, and thereby yield a screened caustic crystallization slurry comprising undersized solids; and filtering the screened caustic crystallization slurry to separate out the undersized solids, and thereby yield the caustic leach recycle stream.

The method may include returning the undersized solids to the crystallization process as seeds.

The method may include subjecting the separated oversized solids to at least one of a drying process and a calcining process.

The method may include subjecting the filter cake comprising the target shred material to a second caustic leaching process to yield a secondary pregnant leach solution; and filtering the secondary pregnant leach solution to yield a refined filter cake comprising the target shred material, and a secondary filtered leach stream.

The method may include feeding the caustic leach recycle stream to the second caustic leaching process.

The method may include returning the secondary filtered leach stream to the caustic leaching process.

The method may include carrying out the caustic leaching process at a temperature of about 100° C.

The method may include carrying out the caustic leaching process at atmospheric pressure.

### BRIEF DESCRIPTION OF THE DRAWINGS

Embodiments of the present invention will be described with reference to the accompanying drawings, wherein like reference numerals denote like parts, and in which:

FIG. 1 is one schematic example of a system for recovering target shred materials, including metals, from battery materials;

FIG. 2 is an example of a method for processing target shred materials using the system of FIG. 1;

FIG. 3 is another example of a system for recovering target shred materials, including metals, from battery materials;

FIG. 4 is an example of a method for processing target shred materials using the system of FIG. 3;

FIG. 5 is another example of a system for recovering target shred materials, including metals, from battery materials;

FIG. 6 is an example of a method for processing target shred materials using the system of FIG. 5;

FIG. 7 is another example of a system for recovering target shred materials, including metals, from battery materials;

FIG. 8 is an example of a method for processing target shred materials using the system of FIG. 8;

FIG. 9 is another example of a system for recovering target shred materials, including metals, from battery materials;

FIG. 10 is an example of a method for processing target shred materials using the system of FIG. 9;

FIGS. 11A and 11B are another example of a system for recovering target shred materials, including metals, from battery materials; and

FIG. 12 is an example of a method for processing target shred materials using the system of FIGS. 11A and 11B.

### DETAILED DESCRIPTION

Various apparatuses or processes will be described below to provide an example of an embodiment of each claimed invention. No embodiment described below limits any claimed invention and any claimed invention may cover processes or apparatuses that differ from those described below. The claimed inventions are not limited to apparatuses or processes having all of the features of any one apparatus or process described below or to features common to multiple or all of the apparatuses described below. It is possible that an apparatus or process described below is not an embodiment of any claimed invention. Any invention disclosed in an apparatus or process described below that is not claimed in this document may be the subject matter of another protective instrument, for example, a continuing patent application, and the applicants, inventors, or owners do not intend to abandon, disclaim, or dedicate to the public any such invention by its disclosure in this document.

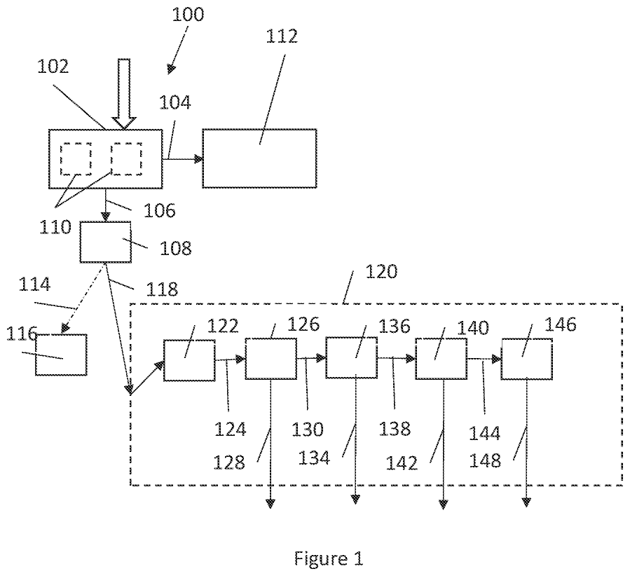

Referring to FIG. 1, one schematic representation of an example of a system 100 for recovering materials from batteries is illustrated. This system 100, in the example illustrated, is configured to recover a variety of materials from incoming battery materials and can be configured to separate and/or recover lithium metal, cobalt, nickel, plastics, copper, aluminum, steel, iron and other such materials from lithium-ion batteries (or other types of batteries) as described herein. The illustrated portions in FIG. 1 may represent only a portion of a larger overall material recovery process that also includes upstream and downstream processing steps (including hydrometallurgical processing steps). While this system 100 and its use to primarily recover target shred materials from the incoming battery materials will be described in detail as an example of the present teachings, other embodiments of the system may also be configured to recover black mass, plastics and other useful product streams, and may be used on other types of lithium batteries and other batteries that do not contain lithium.

In this example, the system 100 includes a primary size reduction apparatus 102 that is configured to receive incoming batteries and/or battery materials (which can include battery backs and other assemblies or subassemblies that include batteries or portions of batteries but can also include packaging, housings, connectors and other materials). One example of a suitable apparatus that can be used as part of the apparatus 102 can be described as an immersion comminuting apparatus that can include a housing that has at least one battery inlet through which battery materials can be introduced into the housing.

The size reduction apparatus 102 preferably has at least a first, submergible comminuting device that can be disposed within the housing and is preferably configured to cause a first or primary size reduction of the battery materials to form reduced-size battery materials (which can include a mixture of size-reduced plastic material, size-reduced metal material and other materials) and to help liberate metals, including lithium or other metals depending on the type of battery being processed, and cathode materials and other metals from within the battery materials.

The size reduction apparatus may include two or more separate comminuting apparatuses in some examples, and each immersion comminuting apparatus may itself have one, two or more submerged comminuting devices contained therein and arranged in series, such that the size reduction apparatus may include two or more size-reduction steps in series and may allow for intervening process steps between the size-reduction steps. For the purposes of the teachings herein, and for distinguishing between any secondary size-reduction that is performed on any of the output streams from the size reduction apparatus 102 as described herein, the overall operations of the first, or primary size reduction apparatus 102 can be described as a first or primary size reduction process, where generally raw or unprocessed incoming battery materials can enter the size reduction apparatus 102 and then one or more streams of size-reduced material that are sent to other process steps are obtained. The content of these post-size reduction apparatus 102 material can be described has having size-reduced or primary-reduced materials (i.e., fragments of the incoming battery materials) regardless of the number of internal size-reduction steps are employed in the size reduction apparatus 102.

For example, a size reduction apparatus 102 with a single shredding stage can receive incoming battery materials, conduct at least a first size reduction and produce primary-reduced materials that are sent for further processing. Similarly. a size reduction apparatus 102 that includes two separate immersion comminuting apparatuses arranged in series (each with at least one submerged comminuting device) and with some product take-off streams between them can also be described as receiving the incoming battery materials, conducting at least a first size reduction process and producing primary-reduced materials for the purposes of the teachings herein.

The immersion material used in the size reduction apparatus 102, preferably an immersion liquid (but optionally a granular solid in some examples), may be provided within the housing of the immersion comminuting apparatus and preferably is configured to submerge at least the first comminuting device, and optionally may also cover at least some of the battery materials. The first size reduction of the battery materials using this apparatus can thereby be conducted under the immersion material (and under immersion conditions) whereby the presence of oxygen is supressed, absorption of heat and the chemical treatment of electrolyte by the immersion liquid. This may also cause the electrolyte materials, the black mass material and the reduced-size plastic and metal materials to become at least partially entrained within the immersion liquid to form a blended material or slurry. Some of the size-reduced material may also float on the immersion liquid. The immersion comminuting apparatus may therefore include a plastics outlet that is positioned toward its upper end and through which a plastics slurry can be extracted, and one or more metal outlets that are provided toward the lower end of the immersion comminuting apparatus and through which a metals slurry or metals outlet stream(s) can be extracted. The metals slurry/outlet stream will likely include a majority of the metal pieces, black mass material and a mixture of the metallic foils, relatively denser plastic materials and other such materials that do not float in the immersion liquid, the cathode materials, electrolyte and immersion material. The plastics slurry may contain a majority of the plastic and other buoyant material but can also include a relatively small amount of the size-reduced metal, black mass material and electrolyte materials as described herein.

The incoming battery materials can be large format batteries or small format batteries, and can include complete battery cells, battery packs and other combinations of batteries, packaging, housings and the like. Large format lithium-ion batteries can be, for example, batteries measuring from about 370 mm×about 130 mm×about 100 mm to about 5000 mm×about 2000 mm×about 1450 mm in size (or volume equivalents; expressed as a rectangular prism for simplification of geometry), and can include electric car batteries or batteries used in stationary energy storage systems. Small format batteries can be, for example, batteries measuring up to about 370 mm×about 130 mm×about 100 mm in size (or volume equivalents; expressed as a rectangular prism for simplification of geometry) and can include portable batteries such as those from cell phones, laptops, power tools or electric bicycles. Large format batteries are generally known in the art to be larger than small format batteries. In another embodiment, the battery materials can comprise battery parts as opposed to whole batteries or battery packs; however, the apparatus, system, and process described herein may be particularly suited to processing whole batteries.

The primary size reduction apparatus 102 is preferably configured so that it can produce at least two, and optionally more output streams that include different components that have been liberated from the incoming battery materials. For example, the primary size reduction apparatus 102 is preferably configured so that a black mass product stream can be extracted containing at least a majority of the black mass material. The black mass stream can be sent for further processing, such as via suitable hydrometallurgy techniques (including those described in PCT patent publication no. WO2018/218358) plastics can be withdrawn via at least one plastic recovery stream and non-plastics, including optionally the black mass material and other materials, such as copper and aluminium foils, can be withdrawn via at least one non-plastic or target shred material recovery streams. This can allow the plastic material to be processed generally separately from the metal or other non-plastic materials.

The size reduction apparatus is preferably configured so that it can complete at least the first size reduction step on in the incoming battery materials under immersion conditions. That is, a size reduction apparatus can have a housing containing a least one comminuting device (e.g., a shredder) that is submerged in a suitable immersion liquid (or other suitable immersion material) while shredding the battery materials. The size reduction apparatus can be any suitable apparatus, including those described herein and those described in PCT patent publication no. WO2018/218358, U.S. Provisional Patent Application No. 63/122,757, and PCT patent application no. PCT/CA2021/050266, each of which are incorporated herein by reference.

The immersion liquid used in the described embodiments may be basic and is preferably at least electrically conductive to help absorb/dissipate any residual electric charge from the incoming battery materials. The immersion liquid may be selected such that it reacts with lithium salt (e.g., LiPF₆) that may be produced via the liberation of the electrolyte materials during the size reduction process, whereby the evolution of hydrogen fluoride during the size reduction is inhibited. The immersion liquid within the housing of the primary immersion apparatus 102 may preferably be at an operating temperature that is less than 70 degrees Celsius to inhibit chemical reactions between the electrolyte materials and the immersion liquid, and optionally the operating temperature may be less than 60 degrees Celsius. The immersion comminuting apparatus can be configured so that the immersion liquid is at substantially atmospheric pressure (i.e., less than about 1.5 bar) when the system is in use, which can simplify the design and operation of the apparatus.

In some examples, the immersion liquid may be at least one of water and an aqueous solution. The immersion liquid may have a pH that is greater than or equal to 8, and optionally may include at least one of sodium hydroxide, calcium hydroxide, and lithium hydroxide. The immersion liquid may include a salt, whereby the immersion liquid is electrically conductive to help at least partially dissipate a residual electrical charge within the battery materials that is released during the size reduction. The salt may include at least one of sodium hydroxide, calcium hydroxide and lithium hydroxide.

Particles that are liberated from the battery materials by the comminuting apparatus 102 during the first size reduction may be captured and entrained within the immersion liquid and may be inhibited from escaping the housing into the surrounding atmosphere. The first comminuting device may be configured as a shredder that is configured to cause size reduction of the battery materials by at least one of compression and shearing. The black mass material obtained using these processes, including at least some residual amounts of the immersion liquid and any electrolytes entrained therein can form the black mass feed materials as described herein.

In the illustrated example, the primary size reduction apparatus 102 is configured so that it can carry out a first size reduction and shred the incoming battery materials via at least one shredding/comminuting device submerged in a suitable immersion liquid, whereby plastics and other relatively light materials will float in the immersion liquid and metals and other relatively heavy materials will tend to sink. The plastic materials can be skimmed or otherwise extracted as a plastics slurry from the shredding/comminuting device via a plastic recovery stream 104. As noted above, the plastics slurry in the plastic recovery stream can include a combination of size-reduced plastic material along with some of the immersion liquid and some metals (including black mass and/or copper and aluminum foils) that are entrained with the liquid and/or stuck to or within the plastic pieces. Material in the plastic recover stream 104 may optionally be further processed to help isolate and facilitate the recovery of at least some desirable plastic material using any suitable downstream plastic processing system 112 and associated method, including the processes described in U.S. provisional patent application No. 63/194,350 which is incorporated herein by reference. While shown schematically as a single box 112, the plastic processing system/method may include a variety of different process steps and the associated equipment.

The primary sized-reduced battery materials exiting the size reduction apparatus 102 can also include a metals outlet stream 106 that exits the primary size reduction apparatus 102. This stream 106 may exit the primary size reduction apparatus 102 as a blended stream/slurry that can include a majority of the black mass materials liberated in the primary size reduction apparatus 102 and/or copper and aluminum foils, steel, iron relatively high-density plastics and other such materials that have been separated from the buoyant plastics. For example, the metals slurry exiting via the metals outlet stream 106 may include at least 60%, 70%, 80%, 90%, 95% wt. or more of the liberated black mass materials, which may be advantageous if the metals outlet stream 106 is to be sent for further processing to separate the metals and preferably recover at least some of the lithium from the black mass. Alternatively, instead of a single metals outlet stream 106 that is further separated downstream as illustrated in this example, other examples of the size reduction apparatus 102 may include two or more separate metals streams 106 each containing a portion of what is described herein.

In the illustrated example, the metals outlet stream 106 can be processed using a first separation apparatus 108 to separate a black mass stream 114 from the combined metals outlet stream 106. The first separation apparatus 108 can include any suitable separation apparatuses and processes, including solid/liquid separators, filters, screens and washing stations and the like. The black mass stream 114 preferably includes a majority of the black mass material exiting the size reduction apparatus 102 and is sent to a suitable hydrometallurgical treatment system 116, such as described in PCT patent publication no. WO2018/218358.

In addition to the black mass stream 114, a target shred material stream 118 can also be formed from the metals outlet stream 106. In this example, the target shred material stream 118 can include copper foil material, aluminum foil material, steel, relatively dense plastics, gold, silver, other precious metals such as the platinum groups metals (PGM) and a relatively small amount of residual black mass material and possibly immersion liquid or other liquid/moisture content that is entrained with or otherwise mixed with the other particles in the target shred material stream 118.

In some examples, the composition of the target shred material stream 118 may be in the ranges as described in Table 1:

TABLE 1

| | Composition (wt %) | | |
|---|---|---|---|
| Component | Max | Avg | Min |
| Aluminum (Al) | 31% | 14% | 5% |
| Copper (Cu) | 58% | 18% | 5% |
| Iron (Fe) | 45% | 24% | 3% |
| PGM/Au/Ag | 40 g/tonne | 12 g/tonne | 4 g/tonne |
| Plastics (Majority HDPE) | 15% | 15% | 15% |
| Black Mass (includes Co, | 15% | 5% | 1%- |
| Ni, Mn, Li, and graphite) | | | |
| Moisture | 20% | 11% | 2% |

Much or the metal content in the target shred material stream 118 may be in the form of shredded foil material having thicknesses of about 1 mm or less (in most battery types) and having been shredded into pieces with widths (lateral dimensions) that are less than about 15 mm and may be less than about 12 mm. The residual black mass may be in relatively fine, powder type format but may be stuck onto the aluminum, copper and other metal flakes. The overall moisture content in the target shred material stream 118 may change over time, particularly if the material is stored before being subjected to further processing. For example, the moisture content may drop to between about 2% and about 5% if the target shred material stream 118 is stored for 1-2 weeks or longer. Prior to further processing the target shred material stream 118 could be purposefully dried to further reduce the moisture content, it could be re-wetted to increase the moisture content or otherwise treated so as to be compatible with the desired downstream processing requirements.

In this example, the target shred material stream 118 can then be processed using a shred processing system 120 that is configured to help separate the various different materials that are contained target shred material stream 118 so that they can preferably be collected separately and sold or sent for further processing. This may help improve the overall recovery efficiency of the system 100 and/or may help reduce the amount of material that is considered waste from the system 100.

In the illustrated example, the shred processing system 120 that receives the target shred material stream 118 can include a variety of different apparatuses, and sub-apparatuses, which can be configured to conduct various separation and/or removal processes. These systems and processes can be arranged in series, as illustrated, and may be performed in different orders. Some examples of different arrangements of the systems and processes involved in the shred processing system 120 are described and illustrated herein, but other arrangements are possible.

Referring to the shred processing system 120 in FIG. 1, this system is configured so that the shred processing system 120 receives the target shred material stream 118 downstream from the primary size reduction apparatus 102, and preferably after the main black mass stream 114 has been separated via the separator 108 (but optionally prior to that stage).

The incoming shred processing system 120 is, in this arrangement, directed to a suitable metal comminuting apparatus 122 that is configured to conduct a subsequent, secondary size-reduction on the incoming plastic and metal material in target shred material stream 118.

The metal comminuting apparatus 122 can include a respective housing and any suitable, secondary comminuting device (or multiple comminuting devices) that can break the relatively large pieces in the incoming plastics slurry into smaller pieces, and can include a dual or quad-shaft shredding device having a pair(s) of contra-rotating, intermeshing shredding rollers with suitable blades to cause the desired size reduction in the battery materials, or other suitable device, that can shred target shred material stream 118 using primarily shear forces. The metal comminuting apparatus 122 can have a housing that contains the shredding rollers, has an inlet to receive the target shred material and at least one outlet via which a size-reduced shred material stream 124 (e.g. a shred metal in which the metal pieces and any included plastics and other materials have been subjected to a further size reduction and are smaller than in the target shred material stream 118 exiting the primary comminuting apparatus 102) can be extracted.

The metal comminuting apparatus 122 can have the same general features as the primary comminuting apparatus 102, or alternatively may be configured as a non-immersion comminuting apparatus in which its shredding blades (or other suitable comminuting device) are not submerged in an immersion liquid when in use. Optionally, the metal comminuting apparatus 122 need not include a shredding type apparatus and may include a grinder, cutter or other suitable equipment that can be used in a submerged environment.

Preferably, the metal comminuting apparatus 122 can be configured so that the particles in the size reduce shred material stream 124 are smaller than the average particles in the target shred material stream 118, and preferably can have an average width (lateral) size of about 5 mm or less, about 2 mm or less, about 1 mm or less, about 0.5 mm or less or other desired sizes.

If desired, the metal comminuting apparatus 122 can including a spraying apparatus that can spray a suitable spray liquid onto the shredding blades of the non-immersion comminuting device and/or incoming material while the apparatus 122 is in use (to help reduce dust, dissipate heat, inhibit of-gassing etc.). The spray liquid can include used or unused immersion liquid, water or other suitable liquids.

The size-reduced, secondary shred material stream 124 can be extracted from the apparatus 122 can continue downstream for processing. Other than being reduced in size, the composition of the secondary shred material stream 124 can be generally similar to that of the target shred material stream 118.

In this example, the secondary shred material stream 124 can then advance to a ferrous separator apparatus 126 that is configured to remove at least some of the iron from within the secondary shred material stream 124, which can be extracted as a ferrous product stream 128. The ferrous separator apparatus 126 may be any suitable apparatus, or combination of apparatuses that can selectively extract/target the iron, steel and other ferrous materials from the secondary shred material stream 124, such as a magnetic separation apparatus. The recovered ferrous metals can be extracted as a ferrous product stream 128. The remaining material can advance downstream as a ferrous-depleted stream 130.

From the ferrous separator apparatus 126, the ferrous-depleted stream 130 can continue for further processing and can be processed to help remove at least some of the black mass material that is mixed in with the foils and other metal particles. In this example, a black mass separation apparatus 136 is illustrated schematically and can include a washing screen or sieving apparatus, a settlement tank and/or other equipment that can help separate mechanically separate the black mass powder from the shred material. A black mass recovery stream 134 which can optionally be recycled upstream in the system 100 and/or may be combined with the black mass stream 104 and processed using the hydrometallurgical system 112.

As the black mass material contains most of the lithium liberated from the battery materials, the resulting stream from the black mass recovery stream 134 can be referred to as a lithium-depleted stream 138 and it has a concentration of lithium that is less than, and preferably substantially less than the concentration of lithium that is in the ferrous-depleted stream 130. This lithium-depleted stream 138 can then be processed in a metals separation apparatus 140 that is configured to selectively separate target metals that include at least one of copper, gold, silver and the platinum group metals from the lithium-depleted stream 138. The target metals that are separated using the metals separation apparatus 140 can be extracted as a target metal product stream 142, and a metals-depleted stream 144, that has a significant concentration of aluminum, dense plastics and other components that have not yet been removed by the upstream processes. This metals separation apparatus 140 can include one or more suitable vessels and/or processes, including solvent extraction systems, precipitation systems (such as a sulphide precipitation system) and other such systems.

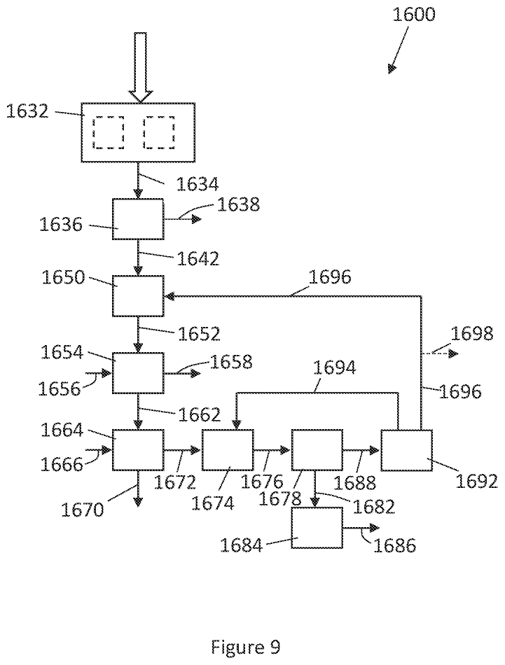

The metals-depleted stream 144 can then advance to an aluminum separation apparatus or system 146 where aluminum can be recovered and collected as an aluminum product stream 148. The aluminum separation apparatus 146 can be any suitable apparatus and/or process, including gravity, and may be a one step or multi-step process that includes several different operations and apparatus, for example as described in relation to FIG. 9. This process may also isolate and collect the dense plastics and other such materials, or further processing may be conducted.

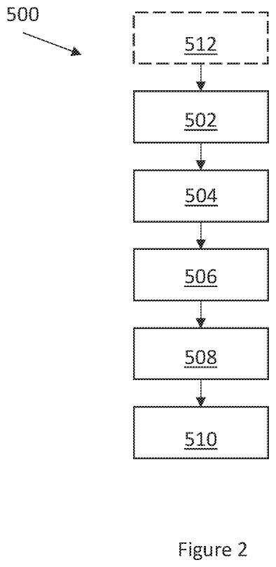

Referring to FIG. 2, a flow chart illustrates one example of a method 500 for recovering metal from battery materials that can be exemplified by the systems, including system 100 described herein. This method 500 includes, at step 502, receiving an incoming target shred material stream (such as stream 118) that can include the coarsely shred material pieces as described herein.

At step 504 the incoming target shred material stream is subject to a secondary, relatively finer size reduction process (such as using apparatus 122) to further reduce the size of the particles in the target shred material stream and produce a size-reduced shred material stream.

At step 506, the size-reduced shred material stream is processed to remove the ferrous metal particles (such as by using apparatus 126), thereby producing a ferrous-depleted stream, which then continues to step 508 where black mass material is separated from the ferrous-depleted stream to produce a lithium-depleted stream.

The lithium-depleted stream can be further processed at step 510 to remove other target metals (such as the copper, platinum, gold and silver separation described herein) and to provide a metal-depleted stream that can be further processed at step 512 to recover at least most of the aluminum that remained in the stream.

The method 500 can also include the optional, upstream step 512 of receiving incoming battery materials and performing a first or initial size reduction on the battery materials under immersion conditions using a suitable, primary comminuting apparatus, to break down the battery materials, liberate the internal metals and black mass material and to break pieces of plastic off of the battery packs and other housing/packaging materials, and then extracting a target shred material stream that includes the components described herein.

The inventors have also discovered that the order of the steps and apparatuses, etc. in the shred processing system 120 can be changed in different embodiments of the present teachings, and that corresponding changes to the order of the steps in method 500 can also be utilized.

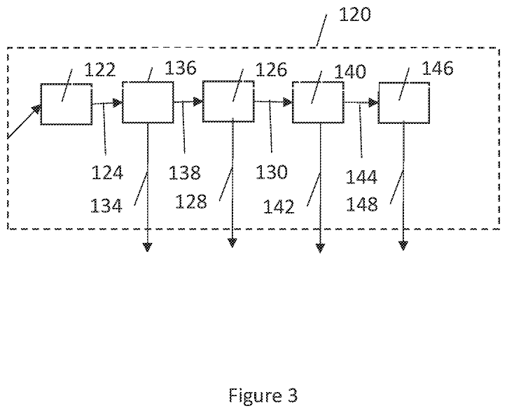

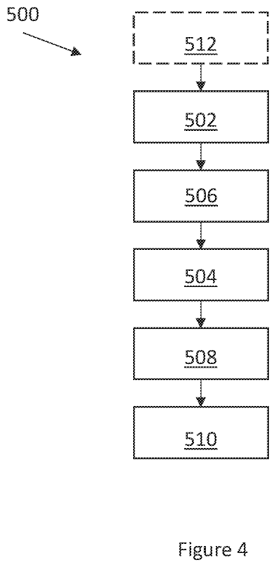

Referring to FIGS. 3 and 4, for example, an alternate configuration of the shred processing system 120 is shown in which the order of the ferrous separator apparatus 126 (and related ferrous product stream 128 and ferrous-depleted stream 130) is swapped with the black mass separation apparatus 136 (and its related black mass recovery stream 134 and lithium-depleted stream 138). FIG. 4 shows the corresponding method, in which the order of steps 504 and 506 have been changed.

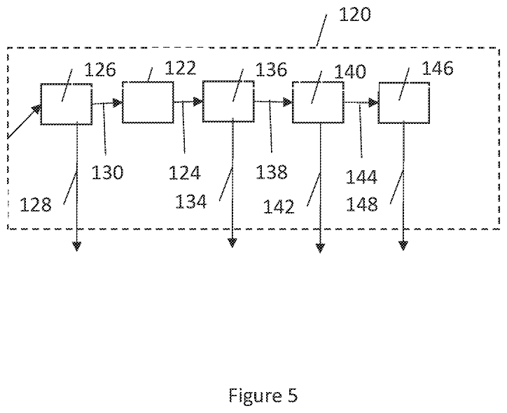

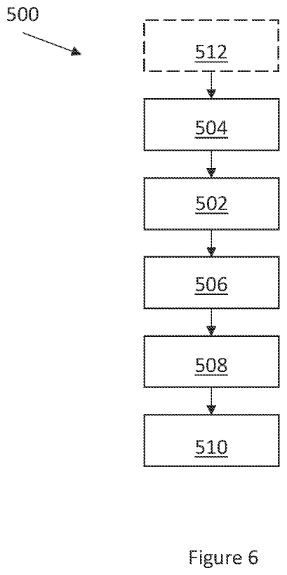

FIGS. 5 and 6 illustrated yet another example of an alternate configuration for the shred processing system 120. In this example, the ferrous separator apparatus 126 (and related ferrous product stream 128 and ferrous-depleted stream 130) is positioned first within the system 120 to directly receive the incoming target shred material stream 118. The secondary, metal comminuting apparatus 122 is then positioned downstream from the ferrous separator apparatus 126 to receive the ferrous-depleted stream 130. This may help reduce the quantity of material that is processed by the ferrous separator apparatus 126, as at least some of the ferrous material was removed via the ferrous product stream 128. FIG. 6 illustrates an example of the method 500 in which step 504 precedes step 502. While these three arrangements are shown as examples, other configurations of the shred processing system 120 are possible, and one or more of the illustrated steps may be optional. That is, some versions of the method 500 need not include all of steps 502, 504, 506, 508 and 510 (and the associated apparatuses and systems). For example, in some examples the shred processing system 120 need not include the metal comminuting apparatus 122 and may omit the secondary size reduction step. Similarly, some examples of the systems and methods described herein may omit the black mass separation steps, or the metals separation step or the aluminum recovery step, for example. Some useful embodiments of the teachings herein may include any two or more of the steps and portions of the shred processing system 120, and preferably may include three or more, or four or more of the steps and portions of the shred processing system 120.

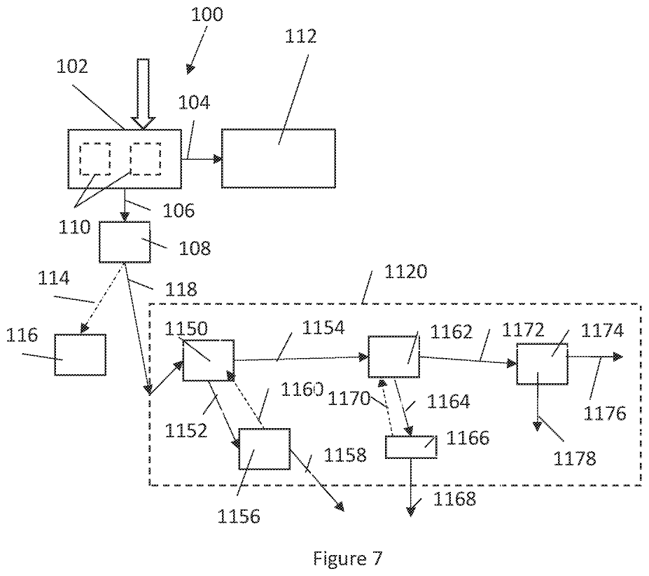

Referring to FIG. 7 another example of a shred processing system 1120 is schematically illustrated. This system 1120 can be configured to receive and process the target shred material stream 118 in a manner that is analogous to how the system 120 are used and, in some examples, may be a supplement and/or an alternative to the systems 120 in the systems and methods described herein.

In this example, the system 1120 can include an initial leaching step that is conducted in a suitable leaching apparatus 1150. Within the leaching apparatus 1150, the incoming target shred material stream 118 can be subjected to a caustic leaching process at a process pH that is preferably greater than or equal to about 9. To obtain the desired operating pH the incoming target shred material stream 118 can be mixed with water and any suitable additive(s) that can give the desired properties of the caustic solution in the leaching apparatus 1150, such as sodium hydroxide. Preferably, the system 1120 can include a pH sensor or other such monitoring system that can measure the pH within the leaching apparatus 1150 while the system 1120 is in use. The pH sensor can be in communication with a suitable system controller so that the operation of the system 1120 can be automatically adjusted based, at least in part, on the pH during the leaching process. For example, the flow rate of the incoming feed material and/or the amounts or rate of adding the sodium hydroxide (or other suitable material) into the process can be adjusted.

The leaching process can be conducted for a leaching period during which aluminum that is contained in the target shred material stream 118 may be preferentially dissolved to form generally soluble aluminum hydroxide.

This leaching process may be exothermic which may tend to increase the temperature of the leach solution. Testing by the inventors has determine that conducting the leaching at relatively higher temperatures (such as at or above about 80 degrees Celsius—as the solubility of the aluminum during the leaching process may increase with temperature) and keeping the pH relatively high and within the target range (e.g. above 9) may help increase the solubility of aluminum hydroxide in the leach solution.

As result of the leaching process, an aluminum hydroxide-rich pregnant leach solution (PLS) can be obtained along with a solid leach residue material that may contain, and be relatively rich with, other components of the target shred material stream 118, including the black mass material, plastics, copper and PGMs, amongst other possible materials.

Preferably, the leach residue material can be separated from the pregnant leach solution such as via filtration or other suitable separation process. The pregnant leach solution containing the dissolved aluminum hydroxide can be extracted as a pregnant leach stream 1152 and can be further processed downstream to isolate and recover the aluminum.

For example, in the illustrated example the aluminum hydroxide-rich pregnant leach stream 1152 can be chilled using any suitable apparatus, such as the crystallizer schematically illustrated at 1156, to produce aluminum oxide, which can be extracted as an aluminum oxide stream 1158. The aluminum oxide stream 1158 may be of relatively high purity and may be sold as a process output in that state or may be further treated and/or processed to help purify or concentrate the output material. The remaining PLS exiting the crystallizer 1156, which is now an aluminum-depleted PLS, may be disposed of or preferably may be recycled somewhere else in the system 1120 or more generally in the system 100. For example, in the illustrated embodiment, the aluminum-depleted PLS is returned to the leaching apparatus 1150 via the optional leach recycle stream 1160.

Separate from the pregnant leach stream 1152, an aluminum-depleted stream 1154 containing the leach residue materials can also be extracted from the leaching apparatus 1150 and further processed. This stream 1154 may be relatively dry when first separated from the aluminum-depleted PLS. Optionally, to help facilitate further processing this leach residue material may be re-slurried, for example by adding water to provide a solution with the desired consistency and flow properties. Other properties of this aluminum-depleted leach residue slurry can also be modified in preparation for further processing. For example, the pH of the leach residue slurry can be adjusted to a target range (such as between about 7 and about 9) by adding a suitable acid (e.g., sulphuric acid) or other additive(s) as appropriate.

The adjusted aluminum-depleted slurry in the stream 1154 can then be processed to separate additional materials. For example, the stream 1154 can be washed using a suitable washing apparatus, such as a washing screen 1162 whereby the black mass material can be separated from the relatively larger particles of copper, plastic, PGM and other material in the stream 1154. The liquid passing through the screen 1162 can be collected as a wash stream 1164 that contains most of the black mass from the stream 1154. The wash stream 1164 can then be optionally further processed to recover the black mass material from the wash liquid. This can be done using any suitable separation technique, including a solid liquid separation process, such as by using a filter apparatus 1166. The solid black mass recovered from the filter apparatus 1166 can be taken as a black mass product stream 1168 which can be sold, sent for further processing and/or routed back to the hydrometallurgical treatment system 116. The filtrate from the filter apparatus 1166 can be sent to waste, further processed, or preferably can be sent as a recycle stream 1170 back to the washing apparatus 1162.

The solid materials that are recovered from the screen 1162 can exit as a black mass depleted stream 1172 that includes the relatively larger particles of copper, plastic, PGM and other materials. This stream 1172 can be further processed using a suitable separator, illustrated schematically as 1174, to separate the plastic material form the copper and other metals. For example, the separator 1174 may include a separation tank in which the copper and other metals may sink while the remaining plastic material floats (and the liquid in the separation tank may be selected to have a suitable density to achieve the desired separation). A plastics stream 1176, and a separate copper-rich metals stream 1178 can be obtained from the separator 1174 in this illustrated example.

The system controllers that can be used in the examples herein may be any suitable computer, processor, programmable logic controller and the like that can be connected to the components of the systems 120 or 1120, such as the vessels, side reduction equipment, flow control mechanisms, chemical holding and distribution equipment, sensors, filters and the like. The system controller can be communicably linked to these various components using any suitable communication hardware/protocol, including wires, wireless connections (such as BlueTooth or WiFi), infrared communication devices, radio transmitters/receivers and the like.

The system controller can include any suitable input and output devices to allow a user to interface with the system, including a keyboard, mouse, track pad or other input device, a monitor/screen, speakers or other sound producing transducers, lights, voice/speech capabilities, an interface with an app or other similar software running on a parallel device (such as a smart phone, tablet or the like) and other suitable devices.

The controller may be a single unit, or the system controller may, in some examples, include multiple different, physical devices that are separate from each other but that a in communication with each other and can function together to perform the functions of the system controller described herein.

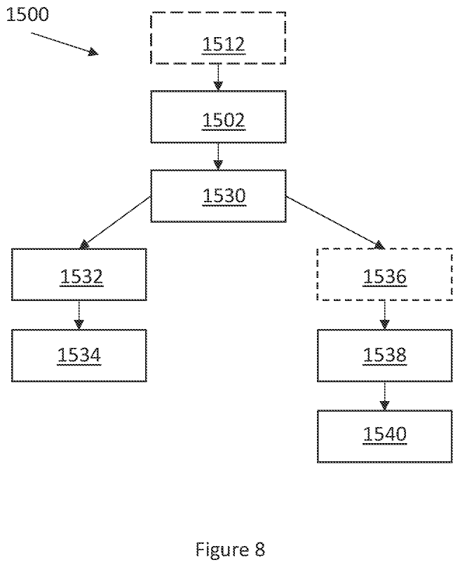

Referring to FIG. 8, another example of a method 1500 for processing battery materials and recovering at least some target shred material from the battery materials using a system, including the system 1200 and/or system 120 if applicable. The method 1500 can include some or all of the features of the method 500 described herein if applicable and may include additional steps beyond what is illustrated in these representative examples.

In this example, the method 1500 includes, at step 1502, receiving an incoming target shred material stream (such as stream 118) that can include the coarsely shred material pieces as described herein.

The method 1500 can then include, at step 1530, leaching the an incoming target shred material stream (for example using leaching apparatus 1150) using a caustic leaching process to help preferentially dissolve aluminum in the an incoming target shred material stream and produce a pregnant leach stream (such as stream 1152) and an aluminum-depleted stream (such as stream 1154) containing the leach residue materials.

At step 1532, the method 1500, can include recovering aluminum oxide from the pregnant leach stream (such as by using a crystallizer 1156), and optionally, at step 1534, recycling at least some of the now aluminum-depleted PLS back into the system for reuse.

Also following the leaching in step 1530, optional step 1536 can include re-slurrying the aluminum-depleted stream and then washing the aluminum-depleted stream at step 1538 (such as using washing screen 1162) to separate black mass material (such as stream 1164) in the aluminum-depleted stream from the relatively larger particles of copper, plastic, PGM and other material. The black mass material can be further processed.

At step 1540, the larger particles of copper, plastic, PGM and other material can be processed to separate the copper and other metals from the plastics, such as by using the separator 1174.

The method 1500 can also include the optional, upstream step 1512 of receiving incoming battery materials and performing a first or initial size reduction on the battery materials under immersion conditions using a suitable, primary comminuting apparatus, to break down the battery materials, liberate the internal metals and black mass material and to break pieces of plastic off of the battery packs and other housing/packaging materials, and then extracting a target shred material stream that includes the components described herein.

Referring to FIG. 9, a schematic representation of another example of a system 1600 for recovering materials from batteries is illustrated. Similar to system 100 described above, system 1600, in the example illustrated, is configured to recover a variety of materials from incoming battery materials, and can be configured to separate and/or recover lithium metal, cobalt, nickel, plastics, copper, aluminum, steel, iron and other such materials from lithium-ion batteries (or other types of batteries) as described herein.

In this example, the system 1600 includes a size reduction apparatus 1632 that is configured to receive incoming batteries and/or battery materials (which can include battery backs and other assemblies or subassemblies that include batteries or portions of batteries but can also include packaging, housings, connectors and other materials). One example of a suitable apparatus that can be used as part of the apparatus 1632 can be described as an immersion comminuting apparatus that can include a housing that has at least one battery inlet through which battery materials can be introduced into the housing.

The size reduction apparatus 1632 preferably has at least a first, submergible comminuting device that can be disposed within the housing and is preferably configured to cause a first or primary size reduction of the battery materials to form reduced-size battery materials (which can include a mixture of size-reduced plastic material, size-reduced metal material and other materials) and to help liberate metals, including lithium or other metals depending on the type of battery being processed, and cathode materials and other metals from within the battery materials.

The size reduction apparatus 1632 may include two or more separate immersion comminuting apparatuses in some examples, and each immersion comminuting apparatus may itself have one, two or more submerged comminuting devices contained therein and arranged in series, such that the size reduction apparatus 1632 may include two or more size-reduction steps in series, and may allow for intervening process steps between the size-reduction steps.

The immersion material used in the size reduction apparatus 1632, preferably an immersion liquid (but optionally a granular solid in some examples), may be provided within the housing of the immersion comminuting apparatus and preferably is configured to submerge at least the first comminuting device, and optionally may also cover at least some of the battery materials. The first size reduction of the battery materials using this apparatus can thereby be conducted under the immersion material (and under immersion conditions) whereby the presence of oxygen is supressed, absorption of heat and the chemical treatment of electrolyte by the immersion liquid. This may also cause the electrolyte materials, the black mass material and the reduced-size plastic and metal materials to become at least partially entrained within the immersion liquid to form a blended material or slurry. Some of the size-reduced material may also float on the immersion liquid.

The incoming battery materials can be large format batteries or small format batteries, and can include complete battery cells, battery packs and other combinations of batteries, packaging, housings and the like, as described above.

The size reduction apparatus 1632 is preferably configured so that it can produce a single, reduced-size battery materials stream 1634 that includes different components that have been liberated from the incoming battery materials.

The size reduction apparatus 1632 is preferably configured so that it can complete at least the first size reduction step of the incoming battery materials under immersion conditions. That is, a size reduction apparatus can have a housing containing a least one comminuting device (e.g., a shredder) that is submerged in a suitable immersion liquid (or other suitable immersion material) while shredding the battery materials. The size reduction apparatus can be any suitable apparatus, including those described herein and those described in PCT patent publication no. WO2018/218358, U.S. Provisional Patent Application No. 63/122,757, and PCT patent application no. PCT/CA2021/050266, each of which are incorporated herein by reference.

The immersion liquid used in the described embodiments may be basic and is preferably at least electrically conductive to help absorb/dissipate any residual electric charge from the incoming battery materials. The immersion liquid may be selected such that it reacts with lithium salt (e.g., LiPF₆) that may be produced via the liberation of the electrolyte materials during the size reduction process, whereby the evolution of hydrogen fluoride during the size reduction is inhibited. The immersion liquid within the housing of the primary immersion apparatus 1632 may preferably be at an operating temperature that is less than 70 degrees Celsius to inhibit chemical reactions between the electrolyte materials and the immersion liquid, and optionally the operating temperature may be less than 60 degrees Celsius. The immersion comminuting apparatus can be configured so that the immersion liquid is at substantially atmospheric pressure (i.e., less than about 1.5 bar) when the system is in use, which can simplify the design and operation of the apparatus.

In some examples, the immersion liquid may be at least one of water and an aqueous solution. The immersion liquid may have a pH that is greater than or equal to 8, and optionally may include at least one of sodium hydroxide, calcium hydroxide, and lithium hydroxide. The immersion liquid may include a salt, whereby the immersion liquid is electrically conductive to help at least partially dissipate a residual electrical charge within the battery materials that is released during the size reduction. The salt may include at least one of sodium hydroxide, calcium hydroxide and lithium hydroxide.

Particles that are liberated from the battery materials by the size reduction apparatus 1632 during the size reduction may be captured and entrained within the immersion liquid and may be inhibited from escaping the housing into the surrounding atmosphere. The first comminuting device may be configured as a shredder that is configured to cause size reduction of the battery materials by at least one of compression and shearing.

The reduced-size battery materials stream 1634 exiting the size reduction apparatus 1632 can optionally be fed to a ferrous separator apparatus 1636, which is configured to carry out a ferrous separation process to remove at least some of the ferromagnetic material (such as iron) from the reduced-size battery materials stream 1634. This may preferably help separate iron and other ferrous materials from the product streams prior to the leaching process. However, this ferrous separator apparatus 1636 (and associated ferrous separation process step) is optional and need not be included in all embodiments of the systems and methods described herein. In this example, the ferromagnetic material removed by the ferrous separation process can exit the ferrous separator apparatus 1636 as a ferromagnetic product stream 1638. The ferrous separator apparatus 1636 can be any suitable apparatus, or combination of apparatuses that can selectively extract/target iron, steel and other ferrous materials from the reduced-size battery materials stream 1634, such as a magnetic separation apparatus. The remaining material can advance downstream as a reduced-size ferrous depleted battery materials stream 1642.

The system 1600 comprises a caustic leaching apparatus 1650 configured to carry out a caustic leaching process. Within the caustic leaching apparatus 1650, the incoming reduced-size ferrous depleted battery materials stream 1642 can be subjected to caustic leaching at a process pH that is greater than 9, preferably greater than 10, more preferably greater than 11, still more preferably greater than 12, still more preferably greater than 13, and most preferably about 14 or greater. To obtain the desired operating pH the incoming metals outlet stream 1642 can be mixed with water and any suitable additive(s) that can give the desired properties of the caustic solution in the caustic leaching apparatus 1650, such as sodium hydroxide, potassium hydroxide, and the like. The caustic leaching apparatus 1650 may, for example, comprise a vessel containing an aqueous solution of sodium hydroxide and/or potassium hydroxide at a molarity of from about 1 to about 10 M NaOH, preferably from about 2 to about 8 M NaOH, more preferably from about 3 to about 7 M NaOH, still more preferably from about 4 to about 6 M NaOH, and most preferably about 5 M NaOH. During operation of the caustic leaching apparatus 1650, the leaching solution is held at an operating pressure of 0.8 to 1.2 times atmospheric pressure, preferably 0.85 to 1.15 times atmospheric pressure, more preferably 0.9 to 1.1 times atmospheric pressure, still more preferably 0.95 to 1.05 times atmospheric pressure, and most preferably at about atmospheric pressure. Additionally, the leaching solution is held at a temperature that is 0.7 times or greater than its boiling point at the operating pressure, preferably between 0.8 and 0.99 times its boiling point at the operating pressure, more preferably between 0.85 and 0.97 times, still more preferably between 0.88 and 0.95 times, still more preferably between 0.90 and 0.93 times, and most preferably about 0.92 times its boiling point at the operating pressure. In one example, the caustic leaching apparatus 1650 comprises a vessel containing an aqueous solution of sodium hydroxide at a molarity of about 5 M NaOH, held at a temperature about 75, 80, 85, 90, 95, 100 or 105 degrees Celsius under about atmospheric pressure. Preferably, the system 1600 can include a pH measurement apparatus (not shown), such as a titration unit or an inductively coupled plasma atomic emission spectroscopy (ICP-AES) analysis instrument, for measuring pH within the caustic leaching apparatus 1650 while the system 1600 is in use. The pH measurement apparatus can be in communication with a suitable system controller, so that the operation of the system 1600 can be automatically adjusted based, at least in part, on the pH during the caustic leaching process, so as to advantageously maintain a generally constant pH level, and in turn to advantageously maintain a generally constant leach rate, for the caustic leaching process. For example, the system controller can adjust the flow rate of the incoming feed material, the amounts or rate of adding the sodium hydroxide/potassium hydroxide (or other suitable material), and/or the amounts or rate of adding a recycle feed stream (described below), into the process.

This leaching process may be exothermic which may tend to increase the temperature of the leach solution. Testing by the inventors has determined that conducting the leaching at relatively higher temperatures (such as at or above about 80, 85, 90, 95, 100 degrees Celsius and possibly higher temperatures if possible but preferably staying below the boiling point of the caustic leach solution—as the solubility of the aluminum during the leaching process may increase with temperature) and keeping the pH relatively high and within the target range (e.g. above 12, 12.5, 13 or 13.5, and preferably approximately at or above 14) may help increase the solubility of aluminum in the leach solution. As will be understood, the solubility of aluminum in the leach solution depends on temperature, caustic concentration, and impurity concentration. This solubility relationship is generally described by various empirical relationships, and therefore the system controller can be configured to utilize the empirical relationships with these three (3) to calculate solubility of aluminum under various operating conditions.

In this embodiment, the leaching process is described as being a batch process conducted for a leaching period during which aluminum that is contained in the incoming reduced-size ferrous depleted battery materials stream 1642 may be preferentially dissolved to form an aluminum-rich pregnant leach solution, which contains aluminum ions in solution. The leaching period may be between about 6 hours and about 72 hours, preferably between about 9 hours and about 36 hours, more preferably between about 10 hours and about 30 hours, and most preferably between about 12 hours and about 24 hours. Alternatively, the leaching process can be a continuous process conducted for a leaching period (namely, a residency time within the continuous process) in which caustic leaching apparatus 1650 may, for example, comprise a suitable vessel, enclosure, tubing, or other structure, configured for continuous processing, to form an aluminum-rich pregnant leach solution.

As result of the leaching process, the aluminum-rich pregnant leach solution is output from the caustic leaching apparatus 1650 as a pregnant leach stream 1652.

The pregnant leach stream 1652 can then be screened using a suitable physical separation apparatus that can separate at least some of the solids from the liquids in the pregnant leach stream 1652, which could include a screening apparatus, such as a shred screen apparatus 1654, whereby solids of predetermined relatively large size in the pregnant leach stream 1652 can be separated from other components in the stream 1652, namely solids of smaller size and liquid. The shred screen apparatus 1654 can comprise a physical separation device, such as a mesh or a screen, having openings that allow liquid and solids that are sized smaller than the openings (“undersized solids”), to pass through, while collecting solids that are sized larger than the openings (“oversized solids”). In this example, the shred screen apparatus 1654 can comprise a screen having openings of 500 microns in size, although the screen can alternatively have openings of other sizes, and the shred screen apparatus 1654 can comprise single or multiple screens having openings of the same or different sizes.

The shred screen apparatus 1654 can utilize a liquid wash stream, such as a wash water stream 1656 which is configured rinse or wash oversized solids separated by the screen with a suitable wash liquid, for recovering caustic from the separated, oversized solids. The shred screen apparatus 1654 can be configured such that the wash water stream 1656 rinses the separated, oversized solids directly on the screen, as they are being conveyed to the screen, and/or after they have been removed from the screen. Caustic rinsed or washed from the separated, oversized solids by the wash water stream 1656 can be combined, such as by gravity, with the liquid and the undersized solids that have already passed through the screen, such that any residual caustic on the separated, oversized solids is returned to the system and is thereby recovered for optional recycling back into the system or for disposal.

Oversized solids separated by the shred screen apparatus 1654, which are rich in copper, can be output as a copper rich product 1658. The copper rich product 1658 can be in the general form of foils and can have a composition that is rich in copper and deficient in aluminum and can be sold for example to copper processors or sent for further processing. Undersized solids and liquid, including any rinse or wash liquid, collected by the shred screen apparatus 1654 can be output as a screened leach stream 1662. The screened leach stream 1662 is rich in black mass and aluminum, and contains most, if not all, of the caustic contained in the pregnant leach stream 1652.

The screened leach stream 1662 can then be processed to recover the black mass material. This can be done using any suitable separation technique, including a solid liquid separation process, such as by using a filter apparatus 1664. The filter apparatus 1664 can comprise a filter and can be configured to collect solids in the form of a filter cake that is rich in black mass.

The filter apparatus 1664 can utilize a liquid wash stream, such as wash water stream 1666 which is configured rinse or wash the filter cake separated by the filter with a suitable wash liquid, for recovering caustic therefrom. The filter apparatus 1664 can be configured such that the wash water stream 1666 rinses the separated filter cake directly on the filter, and/or after it has been removed from the filter. Caustic rinsed or washed from the separated filter cake by the wash water stream 1666 can be combined, such as by gravity, with the filtrate that has already passed through the filter, such that any residual caustic on the separated filter cake is returned to the system and is thereby recovered for optional recycling back into the system of for disposal.

The washed filter cake separated by the filter apparatus 1664 can be taken as a black mass product stream 1670 which can be sold, sent for further processing, or combined with other black mass streams from other systems (such as black mass stream 114, for example). The filtrate from the filter apparatus 1664, which is now substantially depleted of black mass and copper, but rich in dissolved aluminum and caustic, can exit as an aluminum rich, filtered leach stream 1672. This aluminum rich leach stream 1872 can include at least a majority of the aluminum that was including in the incoming the size-reduced battery materials to be processed (such as at least 50%, 60%, 70%, 80%, 90% or more) and is preferably substantially depleted of black mass and copper (e.g., containing less than about 20%, 15%, 10%, 5% or less of the total amount of either black mass or copper materials that were present in the incoming the size-reduced battery materials to be processed)

The filtered, aluminum rich leach stream 1672, which comprises a caustic solution that is relatively rich in aluminum, and relatively depleted in copper and black mass, can for example be output from the system and, for example, be sold or be subjected to further processing in another, external system or by an external apparatus.

Alternatively, and in this embodiment, the filtered, aluminum rich leach stream 1672 can be treated with any suitable aluminum separation apparatus or system, which can include any suitable apparatuses and processes steps that can be used to extract aluminum containing materials from the filtered, aluminum rich leach stream 1672. In this embodiment, the aluminum separation system can include some or all of the apparatuses 1674, 1678, 1692, 1684 that are described below, and can utilize some or all of the processes steps associated therewith.

In this example, the filtered, aluminum rich leach stream 1672 is sent to a crystallization process carried out in a crystallization apparatus 1674 to form crystalline solids of one or more aluminum hydroxides, such as AlOH, Al(OH)₃, and the like. The crystallization apparatus 1674, which may comprise a temperature-controlled vessel such as a refrigerated tank, is configured to cool the incoming filtered leach stream 1672 to a crystallization temperature, and to hold the cooled filtered leach stream 1672 at the crystallization temperature for a crystallization period during which crystalline solids of the one or more aluminum hydroxides precipitate from solution.

As will be understood, solid particles present in the filtered leach stream 1672 exiting the filter apparatus 1664 can serve as nuclei or “seeds” for crystallization during the crystallization process carried out in the crystallization apparatus 1674. Additionally, the crystallization apparatus 1674 can be configured to receive a separate feed of aluminum hydroxide solids (described below), which can provide nuclei or seeds for crystal growth during the crystallization process. The separate feed of aluminum hydroxide solids can come from either a prior processing step, or a subsequent processing step, used in the system 1600.

The crystallization process carried out in the crystallization apparatus 1674 can be a batch process, and the crystallization period can be between about 6 hours and about 72 hours, preferably between about 9 hours and about 36 hours, more preferably between about 10 hours and about 30 hours, and most preferably between about 12 hours and about 24 hours. Alternatively, the crystallization process carried out in the crystallization apparatus 1674 can be a continuous process, whereby the crystallization apparatus 1674 may, for example, comprise a suitable temperature-controlled vessel, enclosure, tubing, or other structure, configured for continuous crystallization, and whereby the incoming filtered leach stream 1672 is cooled and held at the crystallization temperature for a crystallization period of between about 6 hours and about 72 hours, preferably between about 9 hours and about 36 hours, more preferably between about 10 hours and about 30 hours, and most preferably between about 12 hours and about 24 hours.

After the crystallization process has been carried out, the crystallization apparatus 1674 is configured to output a caustic crystallization slurry 1676, which contains crystalline solids of the one or more aluminum hydroxides suspended in a caustic liquid. As will be understood, the crystalline solids in the caustic crystallization slurry 1676 have a relatively high compositional purity, and can have broad size dispersion (namely, can have a variety of different sizes).

In view of the crystal size dispersion, the caustic crystallization slurry 1676 can be sent to a crystal size classification apparatus 1678 configured to carry out a crystal size classification process. The crystal size classification apparatus 1678 may be any suitable equipment or apparatus configured to separate larger and/or heavier solids in suspension from smaller and/or lighter solids in suspension. The crystal size classification apparatus 1678 may be, for example, a counter current settling apparatus, a hydrocyclone apparatus, or another suitable apparatus.

Oversized solids separated out by the crystal size classification apparatus 1678 can be output as an aluminum hydroxide product stream 1682. As will be understood, the aluminum hydroxide product stream 1682 comprises coarse, crystalline solids of the one or more aluminum hydroxides. The aluminum hydroxide product stream 1682 can optionally be sent to a suitable drying apparatus (not shown), such as an oven or furnace, configured to dry the aluminum hydroxide product stream 1682 to produce dried crystalline solids of the one or more aluminum hydroxides, which can then be subjected to further processing or sold. Additionally, or alternatively (as shown), the aluminum hydroxide product stream 1682 can optionally be sent to a suitable calcining apparatus 1684, such as a kiln or a furnace, configured to carry out a calcining process in which the one or more aluminum hydroxides of the aluminum hydroxide product stream 1682 are converted into one or more aluminum oxides. The calcining apparatus 1684 can yield an aluminum oxide product stream 1686, which can then be sold or subjected to further processing (not shown).

Undersized solids and liquid, which remain after the crystal size classification process, can exit the crystal size classification apparatus 1678 as a screened caustic crystallization slurry 1688.

The screened caustic crystallization slurry 1688 can then be processed to recover the finer crystalline solids of the one or more aluminum hydroxides from suspension. This can be done using any suitable solid-liquid separation technique, such as by using a solid-liquid separation apparatus 1692. The solid-liquid separation apparatus 1692 can include a filter press and can be configured to collect solids in the form of a filter cake. The filter cake recovered from the solid-liquid separation apparatus 1692 can be taken as an aluminum hydroxide recycle stream 1694, which can be returned to the crystallization apparatus 1674 to provide nuclei or seeds for crystal growth during the crystallization process. The filtrate from the solid-liquid separation apparatus 1692, which comprises a caustic solution substantially depleted of aluminum, can be output as a caustic leach recycle stream 1696 and at least a portion of the caustic leach recycle stream 1696 can optionally be returned to the caustic leaching apparatus 1650, for recycling the caustic.

Optionally, a slip stream 1698 may be withdrawn from the caustic leach recycle stream 1696 prior to delivery to the caustic leaching apparatus 1650. As will be understood, by removing a bulk portion of the caustic leach recycle stream 1696, the slip stream 1698 reduces the total amount of organic compounds and/or alcohols accumulating in the system 1600. The slip stream 1698 can be, for example, a removed portion of about 10% to about 50% of the caustic leach recycle stream 1696, preferably about 15% to about 45%, more preferably about 20% to about 40%, still more preferably about 25% to about 35%, and most preferably about 30% of the caustic leach recycle stream 1696. The slip stream 1698 can be either subjected to further processing or disposed of.

In other embodiments, the system 1600 may be differently configured. For example, in one embodiment, the system may alternatively not comprise the size reduction apparatus 1632, and instead may alternatively be configured to receive reduced-size battery materials stream from an external source.

In another embodiment, the system 1600 may alternatively not comprise the crystal size classification apparatus, and the solid-liquid separation apparatus 1692 may alternatively be configured to receive the caustic crystallization slurry 1676 directly from the crystallization apparatus 1674. In one such embodiment, a portion of the filter cake recovered from the solid-liquid separation apparatus 1692, which comprises crystalline solids, can be taken as an aluminum hydroxide recycle stream 1694 and returned to the crystallization apparatus 1674, while the remaining portion of the filter cake can simply be output as an aluminum hydroxide product stream. In one example, the portion of the recovered filter cake can be subjected to a size reduction process (such as milling or grinding) to reduce particle size and returned to the crystallization process. In another example, the portion of the recovered filter cake can be “reslurried” (namely, redispersed in a portion of the caustic leach recycle stream), subjected to an in situ size reduction process (such as agitation and/or ultrasonication) to reduce particle size, and then returned to the crystallization process. In still another example, the portion of the recovered filter cake can be subjected to a first size reduction process (such as milling or grinding) to reduce particle size, redispersed in a portion of the caustic leach recycle stream, subjected to a second, in situ size reduction process (such as agitation and/or ultrasonication) to further reduce particle size, and returned to the crystallization process.

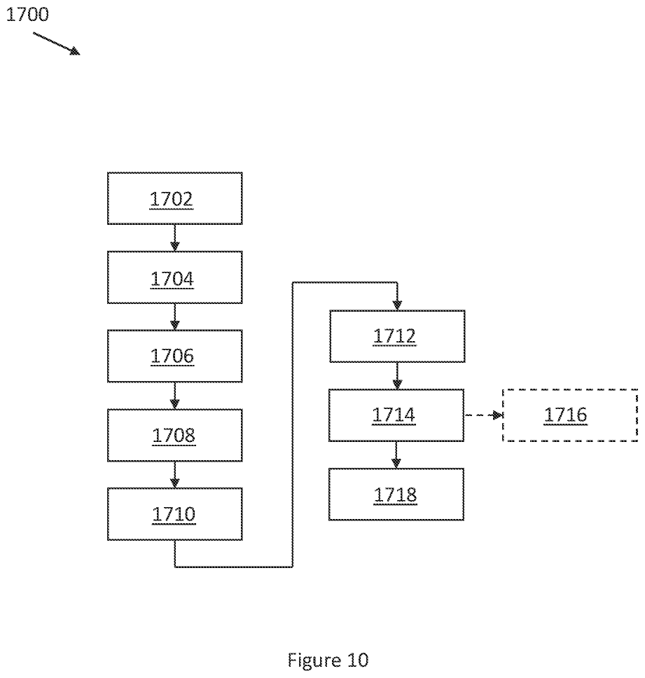

Referring to FIG. 10, a flow chart illustrates an example of a method 1700 for recovering metal from battery materials that can be exemplified by the systems, including system 1600 described herein. This method 1700 includes, at step 1702, receiving an incoming reduced-size battery materials stream (such as stream 1634) that can include the coarsely shred material pieces as described herein.

At step 1704, the reduced-size battery materials stream is subjected to a ferrous separation process (such as using apparatus 1636) to separate out ferromagnetic material therefrom, and to produce a reduced-size ferrous depleted battery materials stream.

At step 1706 the reduced-size ferrous depleted battery materials stream is subjected to a caustic leaching process (such as using apparatus 1650) to dissolve aluminum present in the incoming reduced-size ferrous depleted battery materials stream and to produce a pregnant leach solution.

At step 1708, the pregnant leach solution is subjected to a physical separation process (such as using apparatus 1654) to separate out solids of large size, and thereby provide a screened leach stream. During prior to, and/or after the physical separation process, the separated solids of large size can be rinsed with any suitable wash liquid, which may be water, a solution that includes water with one or more suitable additives or another suitable liquid (such as by using stream 1656) to recover caustic from the separated solids, and to thereby return the caustic to the screened leach stream.

At step 1710, the screened leach stream is filtered (such as using apparatus 1664) to remove black mass in the form of a filter cake, and thereby yield a filtered leach stream that is substantially depleted of black mass. During and/or after the filtering, the separated filter cake can be rinsed with any suitable wash liquid, which may be water, a solution that includes water with one or more suitable additives or another suitable liquid (such as by using stream 1666) to recover caustic from the separated filter cake, and to thereby return the caustic to the filtered leach stream.

At step 1712, the filtered leach stream is subjected to a crystallization process (such as using apparatus 1674), in which aluminum is precipitated from solution as solid crystals of one or more aluminum hydroxides, yielding a caustic crystallization slurry.

The caustic crystallization slurry is subjected to a crystal size classification process (such as using apparatus 1678) at step 1714, to separate out larger crystals (as oversized solids), thereby yielding a screened caustic crystallization slurry comprising smaller crystals (undersized solids) in suspension. Optionally, the oversized solids can be subjected to a calcining process (such as using apparatus 1684) at step 1716, to calcine the one or more aluminum hydroxides into one or more aluminum oxides.

At step 1718, the screened caustic crystallization slurry is subjected to solid-liquid separation (such as using apparatus 1692) to separate out solids (namely, the undersized solids) and thereby yield a caustic leach recycle stream that is substantially depleted of aluminum. The separated solids (namely, the undersized solids) can be returned to the crystallization process, where they can provide nuclei or seeds for crystal growth.

The caustic leach recycle stream can be returned to the caustic leaching process.

Variations are possible. For example, in some embodiments, the caustic crystallization slurry may alternatively not undergo a crystal size classification process, and may alternatively be subjected to solid-liquid separation (such as using apparatus 1692) to separate out solids, some of which can be returned to the crystallization process, and some of which can be subjected to an optional calcining process. In one example, the portion of the recovered filter cake can be subjected to a size reduction process (such as milling or grinding) to reduce particle size and returned to the crystallization process. In another example, the portion of the recovered filter cake can be “reslurried” (namely, redispersed in a portion of the caustic leach recycle stream), subjected to an in situ size reduction process (such as agitation and/or ultrasonication) to reduce particle size, and then returned to the crystallization process. In still another example, the portion of the recovered filter cake can be subjected to a first size reduction process (such as milling or grinding) to reduce particle size, redispersed in a portion of the caustic leach recycle stream, subjected to a second, in situ size reduction process (such as agitation and/or ultrasonication) to further reduce particle size, and returned to the crystallization process.

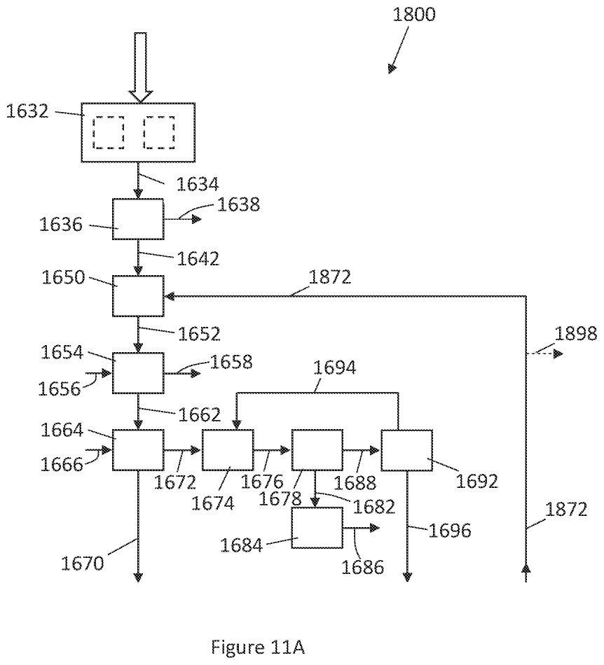

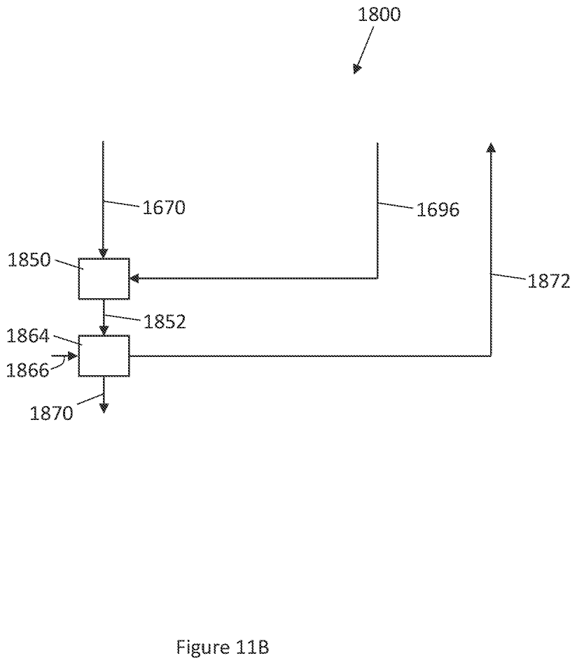

The system may be differently configured. For example, FIGS. 11A and 11B show a schematic representation of another example of a system 1800 for recovering materials from batteries is illustrated. Similar to system 1600 described above, system 1800, in the example illustrated, is configured to recover a variety of materials from incoming battery materials, and can be configured to separate and/or recover lithium metal, cobalt, nickel, plastics, copper, aluminum, steel, iron and other such materials from lithium-ion batteries (or other types of batteries) as described herein.

System 1800 is similar to system 1600 described above, and comprises the size reduction apparatus 1632, the ferrous separator apparatus 1636, the caustic leaching apparatus 1650, the shred screen apparatus 1654, the filter apparatus 1664, the crystallization apparatus 1674, the crystal size classification apparatus 1678, the optional calcining apparatus 1684, and the solid-liquid separation apparatus 1692 described above, all of which operate analogously to the manner described above for system 1600.

However, further to system 1600, system 1800 comprises additional processing steps to which the black mass product stream 1670 exiting the filter apparatus 1664, which is in the form a filter cake that is rich in black mass, is subjected. As shown in FIGS. 11A and 11B, system 1800 comprises a secondary caustic leaching apparatus 1850 configured to carry out an additional, or second caustic leaching process, so as to recover and dissolve any aluminum that might remain the black mass product stream 1670. Similar to caustic leaching apparatus 1650 described above, within the caustic leaching apparatus 1850, the incoming the black mass product stream 1670 can be subjected to caustic leaching at a process pH that is greater than 9, preferably greater than 10, more preferably greater than 11, still more preferably greater than 12, still more preferably greater than 13, and most preferably about 14 or greater. To obtain the desired operating pH the incoming black mass product stream 1670 can be mixed with water and any suitable additive(s) that can give the desired properties of the caustic solution in the secondary caustic leaching apparatus 1850, such as sodium hydroxide, potassium hydroxide, and the like. The secondary caustic leaching apparatus 1850 may, for example, comprise a vessel containing an aqueous solution of sodium hydroxide and/or potassium hydroxide at a molarity of from about 1 to about 10 M NaOH, preferably from about 2 to about 8 M NaOH, more preferably from about 3 to about 7 M NaOH, still more preferably from about 4 to about 6 M NaOH, and most preferably about 5 M NaOH. During operation of the secondary caustic leaching apparatus 1850, the leaching solution is held at an operating pressure of 0.8 to 1.2 times atmospheric pressure, preferably 0.85 to 1.15 times atmospheric pressure, more preferably 0.9 to 1.1 times atmospheric pressure, still more preferably 0.95 to 1.05 times atmospheric pressure, and most preferably at about atmospheric pressure. Additionally, the leaching solution is held at a temperature that is 0.7 times or greater than its boiling point at the operating pressure, preferably between 0.8 and 0.99 times its boiling point at the operating pressure, more preferably between 0.85 and 0.97 times, still more preferably between 0.88 and 0.95 times, still more preferably between 0.90 and 0.93 times, and most preferably about 0.92 times its boiling point at the operating pressure. In one example, the secondary caustic leaching apparatus 1850 comprises a vessel containing an aqueous solution of sodium hydroxide at a molarity of about 5 M NaOH, held at a temperature of about 100 degrees Celsius under about atmospheric pressure. Preferably, the system 1800 can include a pH measurement apparatus (not shown), such as a titration unit or an inductively coupled plasma atomic emission spectroscopy (ICP-AES) analysis instrument, for measuring pH within the secondary caustic leaching apparatus 1850 while the system 1800 is in use. The pH measurement apparatus can be in communication with a suitable system controller, so that the operation of the system 1800 can be automatically adjusted based, at least in part, on the pH during the caustic leaching process. For example, the system controller can adjust the flow rate of the incoming feed material, the amounts or rate of adding the sodium hydroxide/potassium hydroxide (or other suitable material), and/or the amounts or rate of adding a recycle feed stream (described below), into the process.

As shown in FIGS. 11A and 11B, the caustic leach recycle stream 1696 exiting the solid-liquid separation apparatus 1692 can be input into the secondary caustic leaching apparatus 1850 to provide at least a portion of the caustic solution therein.

In this embodiment, the second caustic leaching process is described as being a batch process conducted for a leaching period during which aluminum that is contained in the incoming black mass product stream 1670 may be preferentially dissolved to form a secondary aluminum-rich pregnant leach solution, which contains aluminum ions in solution. Alternatively, the leaching process can be a continuous process conducted for a leaching period (namely, a residency time within the continuous process) in which secondary caustic leaching apparatus 1650 may, for example, comprise a suitable vessel, enclosure, tubing, or other structure, configured for continuous processing, to form an aluminum-rich pregnant leach solution.

After the second caustic leaching process, the secondary aluminum rich pregnant leach solution is output from the secondary caustic leaching apparatus 1850 as a secondary pregnant leach stream 1852.

The secondary pregnant leach stream 1852 can then be processed to recover the black mass material. This can be done using any suitable separation technique, including a solid liquid separation process, such as by using a secondary filter apparatus 1864. The secondary filter apparatus 1864 can comprise a filter and can be configured to collect solids in the form of a filter cake.

The secondary filter apparatus 1864 can have a wash water stream 1866 which is configured rinse or wash the filter cake separated by the filter with water, for recovering caustic therefrom. The secondary filter apparatus 1864 can be configured such that the wash water stream 1866 rinses the separated filter cake directly on the filter, and/or after it has been removed from the filter. Caustic rinsed or washed from the separated filter cake by the wash water stream 1666 can be combined, such as by gravity, with the filtrate that has already passed through the filter, such that any residual caustic on the separated filter cake is returned to the system and is thereby recovered.

The washed filter cake separated by the secondary filter apparatus 1864 can be taken as a refined black mass product stream 1870 which can be sold or sent for further processing. The filtrate from the secondary filter apparatus 1864, which is now substantially depleted of black mass and copper, but rich in dissolved aluminum and caustic, can exit as a secondary filtered leach stream 1872. The secondary filtered leach stream 1872 can be returned to the caustic leaching apparatus 1650 for recycling the caustic.

Optionally, a slip stream 1898 may be withdrawn from the secondary filtered leach stream 1872 prior to delivery to the caustic leaching apparatus 1650. As will be understood, by removing a bulk portion of the secondary filtered leach stream 1872, the slip stream 1898 reduces the total amount of organic compounds and/or alcohols accumulating in the system 1800. The slip stream 1698 can be, for example, a removed portion of about 10% to about 50% of the secondary filtered leach stream 1872, preferably about 15% to about 45%, more preferably about 20% to about 40%, still more preferably about 25% to about 35%, and most preferably about 30% of the secondary filtered leach stream 1872. The secondary filtered leach stream 1872 can be either subjected to further processing or disposed of.

As will be appreciated, owing to the second caustic leaching process and the second filtering, the refined black mass product stream 1870 advantageously has a higher black mass content, and a lower aluminum content, than black mass product stream 1670.

In other embodiments, the system 1800 may be differently configured. For example, in one embodiment, the system may alternatively not comprise the size reduction apparatus 1632, and instead may alternatively be configured to receive reduced-size battery materials stream from an external source.

In another embodiment, the system 1800 may alternatively not comprise the crystal size classification apparatus, and the solid-liquid separation apparatus 1692 may alternatively be configured to receive the caustic crystallization slurry 1676 directly from the crystallization apparatus 1674. In one such embodiment, a portion of the filter cake recovered from the solid-liquid separation apparatus 1692, which comprises crystalline solids, can be taken as an aluminum hydroxide recycle stream 1694 and returned to the crystallization apparatus 1674, while the remaining portion of the filter cake can simply be output as an aluminum hydroxide product stream. In one example, the portion of the recovered filter cake can be subjected to a size reduction process (such as milling or grinding) to reduce particle size and returned to the crystallization process. In another example, the portion of the recovered filter cake can be “reslurried” (namely, redispersed in a portion of the caustic leach recycle stream), subjected to an in situ size reduction process (such as agitation and/or ultrasonication) to reduce particle size, and then returned to the crystallization process. In still another example, the portion of the recovered filter cake can be subjected to a first size reduction process (such as milling or grinding) to reduce particle size, redispersed in a portion of the caustic leach recycle stream, subjected to a second, in situ size reduction process (such as agitation and/or ultrasonication) to further reduce particle size, and returned to the crystallization process.

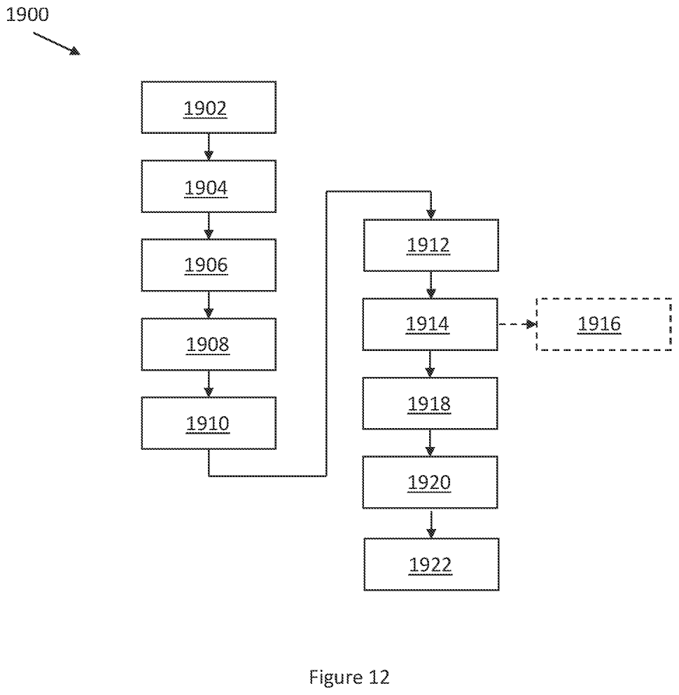

Referring to FIG. 12, a flow chart illustrates an example of a method 1900 for recovering metal from battery materials that can be exemplified by the systems, including system 1800 described herein. This method 1900 includes, at step 1902, receiving an incoming reduced-size battery materials stream (such as stream 1634) that can include the coarsely shred material pieces as described herein.

At step 1904, the reduced-size battery materials stream is subjected to a ferrous separation process (such as using apparatus 1636) to separate out ferromagnetic material therefrom, and to produce a reduced-size ferrous depleted battery materials stream.

At step 1906 the reduced-size ferrous depleted battery materials stream is subjected to a caustic leaching process (such as using apparatus 1650) to dissolve aluminum present in the incoming reduced-size ferrous depleted battery materials stream and to produce a pregnant leach solution.

At step 1908, the pregnant leach solution is subjected to a physical separation process (such as using apparatus 1654) to separate out solids of large size, and thereby provide a screened leach stream. During prior to, and/or after the physical separation process, the separated solids of large size can be rinsed with water (such as by using stream 1656) to recover caustic from the separated solids, and to thereby return the caustic to the screened leach stream.

At step 1910, the screened leach stream is filtered (such as using apparatus 1664) to remove black mass in the form of a filter cake, and thereby yield a filtered leach stream that is substantially depleted of black mass. During and/or after the filtering, the separated filter cake can be rinsed with water (such as by using stream 1666) to recover caustic from the separated filter cake, and to thereby return the caustic to the filtered leach stream.

At step 1912, the filtered leach stream is subjected to a crystallization process (such as using apparatus 1674), in which aluminum is precipitated from solution as solid crystals of one or more aluminum hydroxides, yielding a caustic crystallization slurry.

The caustic crystallization slurry is subjected to a crystal size classification process (such as using apparatus 1678) at step 1914, to separate out larger crystals (as oversized solids), thereby yielding a screened caustic crystallization slurry comprising smaller crystals (undersized solids) in suspension. Optionally, the oversized solids can be subjected to a calcining process (such as using apparatus 1684) at step 1916, to calcine the one or more aluminum hydroxides into one or more aluminum oxides.

At step 1918, the screened caustic crystallization slurry is filtered (such as using apparatus 1692) to separate out solids (namely, the undersized solids) and thereby yield a caustic leach recycle stream that is substantially depleted of aluminum. The separated solids (namely, the undersized solids) can be returned to the crystallization process, where they can provide nuclei or seeds for crystal growth. The caustic leach recycle stream is sent to a second caustic leaching process, described below.

At step 1920 the black mass filter cake is subjected to a second caustic leaching process (such as using apparatus 1850) to dissolve aluminum present in the incoming black mass filter cake and to produce a secondary pregnant leach solution.

At step 1922, the secondary pregnant leach solution is filtered (such as using apparatus 1864) to remove black mass in the form of a refined filter cake, and thereby yield a secondary filtered leach stream that is substantially depleted of black mass. During and/or after the filtering, the separated, refined filter cake can be rinsed with water (such as by using stream 1866) to recover caustic from the separated, refined filter cake, and to thereby return the caustic to the secondary filtered leach stream.

The secondary filtered leach stream can be returned to the caustic leaching process.

Variations are possible. For example, in some embodiments, the caustic crystallization slurry may alternatively not undergo a crystal size classification process, and may alternatively be subjected to solid-liquid separation (such as using apparatus 1692) to separate out solids, some of which can be returned to the crystallization process, and some of which can be subjected to an optional calcining process. In one example, the portion of the recovered filter cake can be subjected to a size reduction process (such as milling or grinding) to reduce particle size and returned to the crystallization process. In another example, the portion of the recovered filter cake can be “reslurried” (namely, redispersed in a portion of the caustic leach recycle stream), subjected to an in situ size reduction process (such as agitation and/or ultrasonication) to reduce particle size, and then returned to the crystallization process. In still another example, the portion of the recovered filter cake can be subjected to a first size reduction process (such as milling or grinding) to reduce particle size, redispersed in a portion of the caustic leach recycle stream, subjected to a second, in situ size reduction process (such as agitation and/or ultrasonication) to further reduce particle size, and returned to the crystallization process.

For the purposes of describing operating ranges and other such parameters herein the phrase “about” means a difference from the stated values or ranges that does not make a material difference in the operation of the systems and processes described herein, including differences that would be understood a person of skill in the relevant art as not having a material impact on the present teachings. For pressures and temperatures about may, in some examples, mean plus or minus 10% of the stated value but is not limited to exactly 10% or less in all situations.

The following examples illustrate various applications of the above-described embodiments.

### Example 1

### Initial Leach and Crystallization Testing

A summary of leach tests SCL-23, SCL-24, SCL-25, SCL-26 and SCL-27 are presented in Table 2. As-received shred material was digested in 5M NaOH with a pulp density (PD) of 20% at 100° C. for 2 hours in tests SCL-25 and 26. Target values of the ratio of Al₂O₃/Na₂CO₃ (hereafter “A/C”), namely the A/C upon complete dissolution of Al in the as-received shred material, is 0.34 in both cases and the maximum theoretical % recovery is 150, meaning that there was more caustic available than required for total Al digestion. Very similar % Al recoveries were observed in both cases at around 84%. Similarly, test SCL-27 reported 87.6% recovery at a test scale that was 3 times larger than previous tests. Tests SCL-23 and SCL-24 were each 2-stage leach in which the residue of test SCL-23 was digested again in 5M caustic with 20% PD. A high recovery of 96.2% can be seen for tests SCL-23 and SCL-24 combined:

TABLE 2

| | Two Stage Leach | | | | |
|---|---|---|---|---|---|
| Test Name | SCL-23 | SCL-24 | SCL-25 | SCL-26 | SCL- 27 |
| Feed | Shred As is | SCL-23 | Shred | Shred | Shred |
| | | Residue | As is | As is | As is |
| Temp (C.) | 100 | 100 | 100 | 100 | 100 |
| Time (hr) | 2 | 2 | 2 | 2 | 3 |
| Solids wt. (g) | 99.0 | 82.1 | 99.5 | 99.8 | 299.8 |
| Pulp Density | 20 | 20 | 20 | 20 | 20 |
| (%) | | | | | |
| Caustic initial | 265 | 265 | 265 | 265 | 265 |
| (g/L Na₂CO₃) | | | | | |
| Caustic final | 221 | 227 | 261 | 213 | 255 |
| (g/L Na₂CO₃) | | | | | |
| Initial A/C | 0 | 0 | 0 | 0 | 0 |
| Target A/C | 0.34 | xx | 0.34 | 0.34 | 0.34 |
| Max | 151.3 | xx | 150.3 | 150.0 | 150 |
| Theoretical | | | | | |
| % Recovery | | | | | |
| Final A/C | 0.25 | 0.02 | 0.30 | 0.32 | 0.29 |
| % Al | xx | 96.2 | 84.7 | 84.1 | 87.6 |
| Recovery | | | | | |

A summary of leach tests SCL-28, SCL-29, SCL-30, SCL-31 and SCL-32 is presented in Table 3. As received shred material was digested in 2M NaOH solution in SCL-28. Note that more Al was added as shred material than the saturation limit, as indicated by the target A/C of 0.78 and the maximum theoretical % recovery of 65. This justifies the observed low Al recovery of 69%.

SCL-29 and SCL-32 utilized 5M NaOH to digest pure Al powder. The target A/C ratio in each case was the saturation limit i.e., 0.51 and high recoveries of 92% and 94% were observed. The final caustic concentration in both cases was higher than the initial value, possibly due to significant evaporation upon addition of the Al powder.

In SCL-30, as-received shred material was added with 33% PD in 5M NaOH with a target A/C of 0.68. The final Al recovery was 75%. Al powder was added in 5M NaOH in SCL-31 to get an initial A/C of 0.30. Shred material was then added in the liquor with a target A/C of 0.64. An Al recovery of 80% was achieved.

TABLE 3

| Test Name | SCL- 28 | SCL-29 | SCL-30 | SCL-31 | SCL-32 |
|---|---|---|---|---|---|
| Feed | Shred | Al | Shred | Al | Al |
| | As is | Powder | As is | Powder + | Powder |
| | | | | Shred | |
| | | | | As is | |
| Temp (C.) | 100 | 100 | 100 | 100 | 100 |
| Time (hr) | 3 | 3 | 4 | 2 | 3 |
| Solids wt (g) | 300.1 | 30.1 | 200.2 | 14.0 + | 30.0 |
| | | | | 100.7 | |
| Pulp Density | 20 | 6 | 33 | 20 | 6 |
| (%) | | | | | |
| Caustic initial | 106 | 265 | 265 | 265 | 265 |
| (g/L NaCO₃) | | | | | |
| Caustic final | 102 | 314 | 234 | 322 | 350 |
| (g/L NaCO₃) | | | | | |
| Initial A/C | 0 | 0 | 0 | 0.30 | 0 |
| Target A/C | 0.78 | 0.51 | 0.68 | 0.64 | 0.51 |
| Max | 65 | 101 | 75 | 71 | 103 |
| Theoretical | | | | | |
| Recovery % | | | | | |
| Final A/C | 0.51 | 0.48 | 0.47 | 0.54 | 0.52 |
| % Al | 69.0 | 91.8 | 74.7 | 80.1 | 94.0 |
| Recovery | | | | | |

The results of crystallization from SCL-28 are summarized in Table 4. The initial caustic concentration in liquor was around 106 g/L Na₂CO₃ with an A/C ratio of 0.51. One key observation between SCL-28P2 and SCL-28P3 is the increase in “% Al crystallized” upon doubling the residence time.

TABLE 4

| Test Name | SCL-28P1 | SCL-28P2 | SCL-28P3 |
|---|---|---|---|
| Feed | SCL-28 | SCL-28 | SCL-28 |
| | Liquor | Liquor | Liquor |
| Seed Temp | 55 | 24 | 24 |
| Time (hr) | 24 | 24 | 48 |
| Liquor wt (g) | 126.3 | 126.1 | 126.3 |
| % Seed | 45 | 45 | 45 |
| Caustic initial (g/L Na₂CO₃) | 102 | 102 | 102 |
| Caustic final (g/L Na₂CO₃) | 91 | 95 | 101 |
| Initial A/C | 0.51 | 0.51 | 0.51 |
| Final A/C | 0.43 | 0.41 | 0.23 |
| % Al Crystallized | 28.0 | 25.8 | 58.1 |

The results of crystallization from SCL-29 are summarized in Table 5. The tests SCL-29P1 and SCL-29P4 crystallized the liquor with an initial caustic concentration of 314 g/L Na₂CO₃, where seeding temperatures were 60° C. and 20° C. and % Al crystallizations were 27% and 29%, respectively. The initial liquor in SCL-29P3 was diluted with water to 143 g/L Na₂CO₃, which maintained the A/C ratio at a lower caustic concentration and crystallization recovery increased to 53%, indicating a negative correlation between initial caustic concentration and % Al recoveries for a given A/C ratio in the crystallization process. In test SCL-29P2, the liquor was diluted with 5M NaOH solution and initial A/C dropped from 0.48 to 0.24 and thus there was virtually no crystallization observed since A/C was at equilibrium.

TABLE 5

| Test Name | SCL-29P1 | SCL-29P2 | SCL-29P3 | SCL-29P4 |
|---|---|---|---|---|
| Feed | SCL-29 Liquor | SCL-29 Liquor + | SCL-29 Liquor + | SCL-29 Liquor |
| | | Caustic (5M) | water | |
| Seed Temp | 60 | 60 | 60 | room |
| Time (hr) | 48 | 48 | 48 | 48 |
| Liquor wt (g) | 110.1 | 110.4 | 109.7 | 101.8 |
| % Seed | 104 | 105 | 105 | 104 |
| Caustic initial | 314 | 287 | 143 | 314 |
| (g/L Na₂CO₃) | | | | |
| Caustic final (g/L | 292 | 264 | 141 | 270 |
| Na₂CO₃) | | | | |
| Initial A/C | 0.48 | 0.24 | 0.48 | 0.48 |
| Final A/C | 0.41 | 0.26 | 0.24 | 0.39 |
| % Al Crystallized | 26.7 | 2.9 | 53.4 | 29.2 |

The summary of crystallization from SCL-30P and SCL-31P are given in Table 6. The initial caustic concentration for SCL-30P was 234 g/L Na₂CO₃, A/C was 0.47 and seed addition was 171%. The final Al recovery was 23% after a 48-hour crystallization residence time. Similarly, SCL-31P was crystallized for 68 hours with a slightly higher initial caustic concentration and A/C and reported 33.5% Al recovery from crystallization. The higher recovery may be attributed to the significantly longer residence time, even though initial caustic concentration was more than that of SCL-30P.

TABLE 6

| Test Name | SCL-30P | SCL-31P |
|---|---|---|
| Feed | SCL-30 Liquor | SCL-31 Liquor |
| Seed Temp | 23 | 50 |
| Time (hr) | 48 | 68 |
| Liquor wt (g) | 109.3 | 215.4 |
| % Seed | 171 | 162 |
| Caustic initial (g/L Na₂CO₃) | 234 | 322 |
| Caustic final (g/L Na₂CO₃) | 224 | 336 |
| Initial A/C | 0.47 | 0.54 |
| Final A/C | 0.37 | 0.34 |
| % Al Crystallized | 23.0 | 33.5 |

The PLS from SCL-32 with 350 g/L Na₂CO₃ and A/C ratio of 0.53 was crystallized with 100% seed for 48 hours after dilution to 268, 233 and 208 g/L Na₂CO₃ in SCL-32P1, SCL-32P2 and SCL-32P3 respectively. The crystallization recoveries increased upon dilution and were 52.1%, 58.6% and, 61.4% respectively as summarized in Table 7.

TABLE 7

| Test Name | SCL-32P1 | SCL-32P2 | SCL-32P3 |
|---|---|---|---|
| Feed | SCL32 | SCL32 | SCL32 |
| | PLS + water | PLS + water | PLS + water |
| Seed Temp | 24 | 24 | 24 |
| Time (hr) | 48 | 48 | 48 |
| Liquor wt (g) | 132.0 | 115.3 | 115.3 |
| % Seed | 92 | 103 | 103 |
| Caustic initial (g/L Na₂CO₃) | 268 | 233 | 208 |
| Caustic final (g/L Na₂CO₃) | 273 | 230 | 197 |
| Initial A/C | 0.53 | 0.53 | 0.53 |
| Final A/C | 0.31 | 0.28 | 0.25 |
| % Al Crystallized | 52.1 | 58.6 | 61.4 |

The initial leach and crystallization testing of this example yielded the following conclusions: i) more free caustic leads to higher Al recovery in leach however lower A/C ratio of the PLS; ii) a lower starting A/C in crystallization will then result in a lower yield per pass; and iii). higher initial A/C ratio, longer residence time, and lower caustic concentration for a fixed A/C, all lead to higher crystallization recoveries.

### Example 2

### Cycle Testing

Aluminum leaching and crystallization were carried out in a series of five cycles to observe the effectiveness of spent liquor recycling, and the impact of impurity build-up. The results are summarized in Tables 8 and 9, respectively. A synthetic spent liquor recycle was prepared for SCL-33L1 by adding Al powder to a 5M NaOH solution. Shred material was leached with 15% PD in a caustic liquor of initial A/C of 0.31 and concentration of 246 g/L Na₂CO₃. It is noteworthy that target A/C and Max theoretical recovery are 0.57 and 76.5%, respectively. This means that more aluminum was added than the saturation limit, and hence the slightly lower recovery of 79% was justified. The slight difference between theoretical and actual recovery can be explained by the inaccuracy of Al analysis in the head or the residue; in other words, the samples were not perfectly representative of the bulk material. The rich liquor from SCL-33L1 was then crystallized after diluting the PLS to 214 g/L Na₂CO₃ and adding 134% seed. The % Al crystallization was 33.1%, and the final A/C of the liquor was 0.37.

TABLE 8

| Test Name | SCL-33L1 | SCL-33L2 | SCL-33L3 | SCL-33L4 | SCL-33L5 |
|---|---|---|---|---|---|
| Date | 26-Oct | 28-Oct | 1-Nov | 5-Nov | 11-Nov |
| Feed | Al Powder + | Al Powder + | Al Powder + | Al Powder + | Al Powder + |
| | Shred | Shred As | Shred As | Shred As | Shred As is |
| | As is | is | is | is | |
| Temp (C.) | 100 | 100 | 100 | 100 | 100 |
| Time (hr) | 2 | 2 | 2 | 2 | 2 |
| Solids wt (g) | 18.7 + | 19.4 + | 16.1 + | 18.4 + | 21.0 + 99.8 |
| | 100.0 | 100.2 | 100.0 | 100.0 | |
| Pulp Density (%) | 15.0 | 15.1 | 15.1 | 14.9 | 15.0 |
| Caustic initial | 246 | 231 | 255 | 266 | 274 |
| (g/L Na₂CO₃) | | | | | |
| Caustic final (g/L | 256 | 240 | 253 | 255 | 266 |
| Na₂CO₃) | | | | | |
| Caustic final | 214 | 189 | 205 | 237 | 234 |
| diluted (g/L | | | | | |
| Na₂CO₃) | | | | | |
| Initial A/C | 0.31 | 0.35 | 0.27 | 0.29 | 0.33 |
| Target A/C | 0.57 | 0.64 | 0.54 | 0.54 | 0.58 |
| Max Theoretical | 76.5 | 61.8 | 89.8 | 86.9 | 73.0 |
| % Al Recovery | | | | | |
| Final A/C | 0.51 | 0.53 | 0.47 | 0.47 | 0.51 |
| % Al Recovery | 79.4 | 75.4 | 73.1 | 69.9 | 73.4 |

TABLE 9

| Test Name | SCL-33P1 | SCL-33P2 | SCL-33P3 | SCL-33P4 | SCL-33P5 |
|---|---|---|---|---|---|
| Feed | SCL-33L1 | SCL-33L2 | SCL-33L3 | SCL-33L4 | SCL-33L5 |
| | PLS | PLS | PLS | PLS | PLS |
| | diluted | diluted | diluted | diluted | diluted |
| Seed Temp | 25 | 25 | 25 | 25 | 25 |
| (C.) | | | | | |
| Time (hr) | 44 | 44 | 44 | 44 | 44 |
| Liquor wt (g) | 540.0 | 549.4 | 534.1 | 569.6 | 555.7 |
| % Seed | 134 | 146 | 159 | 91 | 126 |
| Caustic initial | 214 | 189 | 205 | 237 | 234 |
| (g/L Na₂CO₃) | | | | | |
| Caustic final | 218 | 195 | 227 | 227 | 242 |
| (g/L Na₂CO₃) | | | | | |
| Initial A/C | 0.51 | 0.53 | 0.47 | 0.47 | 0.51 |
| Final A/C | 0.37 | 0.36 | 0.34 | 0.40 | 0.33 |
| % Al | 33.1 | 40.7 | 29.4 | 20.0 | 36.6 |
| Crystallized | | | | | |

The spent liquor from SCL-33P1 was again topped-up with synthetic spent liquor and initial caustic concentration and A/C ratio in SCL-33L2 were 231 g/L Na₂CO₃ and 0.35 respectively. The shred material was added, and final A/C of 0.53 and a recovery of 75% were achieved. The rich liquor was again crystallized by adding 146% seed material and dilution to 189 g/L Na₂CO₃. The final % Al crystallization was 40.7%, and the A/C of the liquor was 0.36. Similarly, 3 more cycles were completed.

The cycle testing of this example led to the following conclusions: i) sufficient recoveries were maintained over 5 cycles for leaching and crystallization; ii) the impact of impurity buildup was not observed during cycle testing; and iii) real time analysis of liquors would have made results more consistent.

### Example 3

### Effects of Time, Seed Quantity and Seed Size

A bulk leach was prepared in SCL-34 to test the effect of time on crystallization. The caustic concentration after dilution was 218 g/L Na₂CO₃ and A/C ratio of 0.54. SCL-34P1, SCL-34P2 and SCL-34P3 were crystallized for 24, 44 and 68 hours respectively. A fixed amount of 74% seed was added in all the tests, and the starting temperature for all cases was 25° C. The crystallization recovery increased with time, and were 21%, 40% and 51%, respectively. The results are summarized in Table 10:

TABLE 10

| Test Name | SCL-34P1 | SCL-34P2 | SCL-34P3 |
|---|---|---|---|
| Feed | SCL-34 PLS diluted | SCL-34 PLS diluted | SCL-34 PLS diluted |
| Seed Temp (C.) | 25 | 25 | 25 |
| Time (hr) | 24 | 44 | 68 |
| Liquor wt (g) | 584.3 | 584.4 | 583.8 |
| % Seed | 72 | 72 | 72 |
| Caustic initial (g/L Na₂CO₃) | 218 | 218 | 218 |
| Caustic final (g/L Na₂CO₃) | 199 | 213 | 224 |
| Initial A/C | 0.54 | 0.54 | 0.54 |
| Final A/C | 0.48 | 0.35 | 0.28 |
| % Al Crystallized | 20.8 | 40.4 | 50.9 |

Another bulk leach was prepared in SCL-35 to test the effect of % seed addition on crystallization. The caustic concentration after dilution of PLS was 186 g/L Na₂CO₃, and the A/C ratio was 0.53. In crystallization tests SCL-35P1, SCL-35P2, SCL-35P3 and SCL-35P4, the values of % seed addition were 52, 105, 157, and 209, respectively, and the crystallization period was 48 hours. The recovery of Al slightly increased between 50-150% seed addition, and slightly dropped at 200%. The recoveries were 52%, 54%, 57%, and 53%, respectively. In SCL-35P5, a finer seed material was used to observe the effect of seed size on crystallization. All other conditions were the same as for SCL-35P2, and a higher crystallization recovery of 66.5% was achieved. The results are summarized in Table 11:

TABLE 11

| | | | | | SCL-35P5 |
|---|---|---|---|---|---|
| Test Name | SCL-35P1 | SCL-35P2 | SCL-35P3 | SCL-35P4 | (Finer Seeds) |
| Feed | SCL-35 PLS | SCL-35 PLS | SCL-35 PLS | SCL-35 PLS | SCL-35 PLS |
| | diluted | diluted | diluted | diluted | diluted |
| Seed Temp (C.) | 25 | 25 | 25 | 25 | 25 |
| Time (hr) | 48 | 48 | 48 | 48 | 48 |
| Liquor wt (g) | 470.0 | 470.1 | 470.1 | 470.0 | 470.5 |
| % Seed | 52 | 105 | 157 | 209 | 105 |
| Caustic initial | 186 | 186 | 186 | 186 | 186 |
| (g/L Na₂CO₃) | | | | | |
| Caustic final (g/L | 194 | 188 | 185 | 207 | 190 |
| Na₂CO₃) | | | | | |
| Initial A/C | 0.53 | 0.53 | 0.53 | 0.53 | 0.53 |
| Final A/C | 0.27 | 0.26 | 0.25 | 0.24 | 0.19 |
| % Al Crystallized | 51.9 | 53.6 | 56.7 | 53.2 | 66.5 |

In the literature, it can be found that the % seed addition beyond an optimum amount can decrease crystallization recoveries since higher number of particles means more collision and shocks causing deagglomeration of particles. However, up to an optimum amount, more particles mean a lesser distance between them and a higher frequency of encounter, and thus more crystallization. Similarly, a finer seed may mean higher surface area, which can improve the kinetics of crystallization.

### Example 4

### Particle Size Analysis

Results of a particle size analysis of seed material (suppled by Alcan) and Al(OH)₃ product from the cycle testing of Example 2 are summarized in Table 12. Fresh seeds were used for each cycle, and it can be observed that D50 and D80 of the product was greater than that of the seed material in each cycle. Similarly, the results of particle size analysis of finer seeds, (namely, supplied Sigma Aldrich) and crystallization products from SCL-35P series are summarized in Table 13. In tests SCL-35P1, SCL-35P2, SCL-35P3 and SCL-35P4, the seed material used was from Alcan while SCL-35P5 utilized finer seeds from Sigma Aldrich, as observed in the values D50 and D80.

TABLE 12

| | Seed | SCL- | SCL- | SCL- | SCL- | SCL- |
|---|---|---|---|---|---|---|
| | Alcan | 33P1 | 33P2 | 33P3 | 33P4 | 33P5 |
| D90 (um) | 58.7 | 65.1 | 65.3 | 63.6 | 64.1 | 65.7 |
| D80 (um) | 47.5 | 52.7 | 52.8 | 50.9 | 51.6 | 52.9 |
| D50 (um) | 27.8 | 32.2 | 32.3 | 30.5 | 31.5 | 32.0 |
| D10 (um) | 7.1 | 8.0 | 9.7 | 7.8 | 8.6 | 8.3 |

TABLE 13

| | Seed | SCL- | SCL- | SCL- | SCL- | SCL- |
|---|---|---|---|---|---|---|
| | Sigma | 35P1 | 35P2 | 35P3 | 35P4 | 35P5 |
| D90 (um) | 30.7 | 50.6 | 47.7 | 56.1 | 58.4 | 42.3 |
| D80 (um) | 23.7 | 36.9 | 38.4 | 44.0 | 47.0 | 26.8 |
| D50 (um) | 13.1 | 11.0 | 21.3 | 24.2 | 27.8 | 11.6 |
| D10 (um) | 3.1 | 0.9 | 1.4 | 2.1 | 4.6 | 1.0 |

Based on this analysis, and the observation that finer seeds increase crystallization recovery, a conclusion can be drawn that classification of seeds from product based on size prior to recycling seed to the crystallizer should be used.

### Example 4

### Dry Screening of Leach Residue

Leach residues were sieved to determine whether the residual Al remaining in the residue would report preferentially to the black mass filter cake product. The leach residues from cycle testing were combined and dry sieved using 500 um screens. The results are summarized Table 14. The residual % Al in oversize (namely, reporting to the copper rich product) is 91% and % Al in undersize (namely, reporting to the black mass filter cake product) is around 9.1%. Based on these results, it appears that the residual Al remaining in the leach residue does not preferentially report with the black mass filter cake product

TABLE 14

| | Mass (g) | % Al | Al (g) |
|---|---|---|---|
| SCL-33L1 residue | 82.8 | 3.6 | 3.0 |
| SCL-33L2 residue | 85.5 | 4.2 | 3.6 |
| SCL-33L3 residue | 82.4 | 4.7 | 3.9 |
| SCL-33L4 residue | 84.1 | 5.5 | 4.6 |
| SCL-33L5 residue | 81.5 | 4.7 | 3.8 |
| Mix residue | 416.5 | 3.4 | 14.0 |
| 500 um Screen Oversize | 327.8 | 5.4 | 17.8 |
| 500 um Screen Undersize | 61.9 | 2.9 | 1.8 |
| % Oversize | 84.1 | | |
| % Undersize | 15.9 | | |
| Al in Oversize | 90.9 | | |
| Al in Undersize | 9.1 | | |

All publications, patents, and patent applications referred to herein are incorporated by reference in their entirety to the same extent as if each individual publication, patent, or patent application was specifically and individually indicated to be incorporated by reference in its entirety. It is understood that the teachings of the present application are exemplary embodiments and that other embodiments may vary from those described. Such variations are not to be regarded as a departure from the spirit and scope of the teachings and may be included within the scope of the following claims.

What is claimed is:

1. A system for processing size-reduced battery materials comprising aluminum, copper and black mass, the system comprising:
a caustic leaching apparatus configured to leach the size-reduced battery materials and dissolve the aluminum contained in the size-reduced battery materials thereby yielding a pregnant leach solution,
a first solid liquid separation apparatus downstream from the caustic leaching apparatus and configured to physically separate a solid, upgraded shred product from the pregnant leach solution thereby producing a screened leach stream, the upgraded shred product comprising solid copper material and having a higher concentration of copper and a lower concentration of aluminum than the screened leach stream; and
a second solid liquid separation apparatus downstream from the first solid liquid separation apparatus configured to separate at least a portion of the black mass from the screened leach stream thereby providing an aluminum rich leach stream that comprises at least a majority of the aluminum from the size-reduced battery materials and is substantially depleted of black mass and copper.

2. The system of claim 1, wherein the second solid liquid separator comprises a filter apparatus configured to filter the screened leach stream to yield a filter cake that comprises the black mass separated from the aluminum rich leach stream.

3. The system of claim 1 or 2, further comprising:
an aluminum separation apparatus downstream from the second solid liquid separation apparatus configured to separate an aluminum product material from the aluminum rich leach stream and optionally wherein the wherein the aluminum product material comprises at least one of aluminum hydroxide and aluminum oxide.

4. The system of claim 1, wherein the aluminum separation apparatus comprises:
a crystallization apparatus configured to subject the aluminum rich leach stream to a crystallization process, thereby yielding a caustic crystallization slurry comprising crystalline solids that contain the aluminum product material.

5. The system of claim 4, wherein the aluminum product material in the crystalline solids comprises one or more of aluminum hydroxide and aluminum trihydroxide, and optionally further comprising, downstream from the crystallization apparatus, a drying apparatus oven configured to dry the crystalline solids that contain the aluminum product material into a dried crystalline solid comprising aluminum, and optionally further comprising calcinating apparatus downstream from the drying apparatus to calcine the dried crystalline solid comprising aluminum into an aluminum oxide product.

6. The system of claim 4, further comprising:
a third solid-liquid separation apparatus configured to filter the caustic crystallization slurry to separate out the crystalline solids, and thereby yield a caustic leach recycle stream.

7. The system of claim 6, wherein at least a portion of the crystalline solids are returned to the crystallization apparatus as crystallization seeds used in the crystallization process.

8. The system of claim 7, further comprising:
a particle size reduction apparatus downstream from the third solid-liquid separator and configured to reduce a particle size of the crystalline solids to yield reduced size crystalline solids, wherein the reduced size crystalline solids are returned to the crystallization apparatus as the crystallization seeds.

9. The system of claim 7, further comprising:
a particle size reduction apparatus downstream from the third solid-liquid separator and configured to reduce a particle size of the crystalline solids and produce reduced size crystalline solids and disperse at least a portion of the reduced size crystalline solids in a portion the caustic leach recycle stream, to yield a reduced particle size slurry, and wherein the reduced particle size slurry is returned to the crystallization apparatus to provide the crystallization seeds.

10. The system of claim 7, further comprising:
a first particle size reduction apparatus downstream from the third solid-liquid separator and configured to reduce a particle size of the crystalline solids to yield reduced size crystalline solids; and
a second particle size reduction apparatus disposed downstream from the first particle size reduction apparatus and configured receive the reduced size crystalline solids and to further reduce a particle size of the reduced size crystalline solids, once redispersed in a portion the caustic leach recycle stream, to yield a reduced particle size slurry, wherein the reduced particle size slurry is returned to the crystallization apparatus to provide the crystallization seeds.

11. The system of claim 6, wherein the aluminum separation apparatus is configured so that at least a portion of the caustic leach recycle stream is directed to the caustic leaching apparatus whereby it is returned to the caustic leaching process.

12. The system of claim 11, wherein the aluminum separation apparatus is configured to extract a slip stream that comprises a portion of the caustic leach recycle stream between the and the caustic leaching apparatus and the third solid-liquid separator and prior to the caustic leach recycle stream being returned to the caustic leaching apparatus, thereby reducing an amount of the caustic leach recycle stream that reaches the caustic leach apparatus and inhibiting an accumulation of impurities introduced into the caustic leaching apparatus via the caustic leach recycle stream.

13. The system of claim 12, wherein the impurities in the caustic leach recycle stream comprise one or more of organic compounds and alcohols.

14. The system of claim 23, wherein the slip stream comprises between about 10% to about 50% of the volume of the caustic leach recycle stream, preferably between about 15% to about 45%, more preferably between about 20% to about 40%, still more preferably between about 25% to about 35%, and most preferably between about 30% of the caustic leach recycle stream

15. The system of claim 6, further comprising, upstream from the third solid-liquid separation apparatus:
a crystal size classification apparatus configured to separate out oversized crystalline solids, and thereby yield a screened caustic crystallization slurry comprising undersized crystalline solids, wherein the screened caustic crystallization slurry is fed into the solid-liquid separation apparatus as the caustic crystallization slurry.

16. The system of claim 15, wherein the crystal size classification apparatus comprises one or more of a counter current settling apparatus and a hydrocyclone apparatus.

17. The system of claim 15, wherein the undersized crystalline solids are returned to the crystallization apparatus as crystallization seeds.

18. The system of claim any one of claims 1 to 17, further comprising:
a second caustic leaching apparatus configured to leach the filter cake to yield a secondary pregnant leach solution; and
a second filter apparatus configured to filter the secondary pregnant leach solution to yield a refined filter cake that is rich in black mass and a secondary aluminum rich leach stream, the refined filter cake having a lower aluminum concentration than the filter cake.

19. The system of claim 18, further comprising:
a crystallization apparatus downstream from the second solid liquid separation apparatus and configured to subject the aluminum rich leach stream to a crystallization process, to yield a caustic crystallization slurry comprising crystalline solids; and
a fourth solid-liquid separation apparatus configured to filter the caustic crystallization slurry to separate out the crystalline solids, and thereby yield a caustic leach recycle stream,
wherein the caustic leach recycle stream is fed into the second caustic leaching apparatus.

20. The system of claim 18, wherein the secondary aluminum rich leach stream is returned to the caustic leaching process.

21. The system of any one of claims 1 to 20, wherein the size-reduced battery materials has a first aluminum concentration, a first copper concentration, and a first black mass concentration; and wherein
the oversized solids have a second copper concentration that is higher than the first copper concentration; and
the filter cake has a second black mass concentration that is higher than the first black mass concentration.

22. The system of any one of claims 1 to 21, wherein the caustic leaching apparatus comprises a caustic leaching solution having a pH that is greater than 9.

23. The system of claim 22, wherein the caustic leaching solution pH is greater than 10, more preferably greater than 11, still more preferably greater than 12, still more preferably greater than 13, and most preferably 14 or higher.

24. The system of claim 22 or 23, wherein the caustic leaching solution has a NaOH concentration of between about 1 to about 10 M, preferably from about 2 to about 8 M, more preferably from about 3 to about 7 M, still more preferably from about 4 to about 6 M, and most preferably about 5 M.

25. The system of any one of claims 22 to 24, wherein the caustic leaching apparatus is configured so that the caustic leaching solution at an operating pressure that is between 0.8 to 1.2 times atmospheric pressure, preferably 0.85 to 1.15 times atmospheric pressure, more preferably 0.9 to 1.1 times atmospheric pressure, still more preferably 0.95 to 1.05 times atmospheric pressure.

26. The system of claim 25, wherein the operating pressure is about atmospheric pressure.

27. The system of any one of claim 25 or 26, wherein the caustic leaching apparatus is configured so that the caustic leaching solution at a temperature that is between 0.7 times its boiling point at the operating pressure and its boiling point at the operating pressure, preferably between 0.8 and 0.99 times, more preferably between 0.85 and 0.97 times, still more preferably between 0.88 and 0.95 times, still more preferably between 0.90 and 0.93 times, and most preferably about 0.92 times its boiling point at the operating pressure.

28. The system of any one of claims 22 to 27, wherein the caustic leaching solution is held at a temperature of about 75, 80, 85, 90, 95, 100 or 105° C.

29. The system of claims 22 to 28, further comprising a titration unit configured to control a caustic concentration of the caustic leaching solution.

30. The system of any one of claims 1 to 29, wherein the first solid liquid separation apparatus comprises a screen or a sieve.

31. The system of claim 1, wherein the first solid liquid apparatus has openings configured to catch solid particles that are about 500 μm in size or larger.

32. The system of any one of claims 1 to 31, further comprising a washing apparatus configured to rinse the upgraded shred product with a washing liquid to remove residual caustic leaching solution from the upgraded shred product.

33. The system of any one of claims 1 to 32, wherein the second solid liquid separation apparatus comprises a washing apparatus configured to rinse the filter cake with a washing liquid to remove residual caustic leaching solution from the filter cake.

34. The system of any one of claims 1 to 33, further comprising a size reduction apparatus upstream from the first solid liquid separation apparatus and configured to receive battery materials and to generate the size-reduced battery materials, the size reduction apparatus comprising an immersion comminuting apparatus having a housing containing an immersion liquid, at least one battery inlet through which the battery materials can be introduced into the housing, at least a first, submergible comminuting device disposed within the housing submerged in the immersion liquid and configured to cause a primary size reduction of the battery materials and release the copper, aluminum and black mass materials from within the battery materials to form reduced-size battery materials.

35. The system of any one of claims 1 to 34, further comprising a ferrous separator apparatus disposed between the size reduction apparatus upstream from the first solid liquid separation apparatus configured to remove at least some ferromagnetic material from the size-reduced battery materials exiting the size reduction apparatus before the size-reduced battery materials enter the caustic leaching apparatus.

36. The system of claim 35, wherein the ferrous separator apparatus comprises a magnetic separation apparatus.

37. A method of processing size-reduced battery materials comprising aluminum, copper and black mass, the method comprising:
leaching the size-reduced battery materials using a caustic leaching apparatus containing a caustic leach solution to yield a pregnant leach solution;
separating a solid, upgraded shred product comprising solid copper material from the pregnant leach solution using a first solid liquid separation apparatus thereby producing a screened leach stream having a lower concentration of copper and a higher concentration of aluminum than upgraded shred product; and
separating at least a portion of the black mass material from the screened leach stream using a second solid liquid separator and obtaining an aluminum rich leach stream that comprises at least a majority of the aluminum from the size-reduced battery materials and is substantially depleted of at least one of black mass and copper.

38. The method of claim 37, wherein the second solid liquid separator comprises a filter and separating at least a portion of the black mass material from the screened leach stream comprises collecting a filter cake that comprises the black mass separated from the aluminum rich leach stream using the filter.

39. The method of claim 37 or 38, further comprising:
separating an aluminum product material, that comprises optionally at least one of aluminum hydroxide and aluminum oxide, and a caustic product from the aluminum rich leach stream using an aluminum separation apparatus.

40. The method of claim 37 or 38, further comprising:
subjecting the aluminum rich leach stream to a crystallization process to yield a caustic crystallization slurry comprising crystalline solids.

41. The method of claim 40, wherein the crystalline solids comprise one or more of aluminum hydroxide and aluminum trihydroxide.

42. The method of claim 40, further comprising:
separating the crystalline solids from the caustic crystallization slurry using a solid-liquid separation process to provide a caustic leach recycle stream.

43. The method of claim 42, further comprising:
returning at least a portion of the crystalline solids to the crystallization apparatus as crystallization seeds.

44. The method of claim 43, further comprising:
reducing a particle size of the crystalline solids to yield reduced size crystalline solids; and
returning the reduced size crystalline solids to the crystallization apparatus as the crystallization seeds.

45. The method of claim 43, further comprising:
redispersing the crystalline solids in a portion of the caustic leach recycle stream;
reducing a particle size of the redispersed crystalline solids to yield a reduced particle size slurry; and
returning the reduced particle size slurry to the crystallization apparatus to provide the crystallization seeds.

46. The method of claim 43, further comprising:
reducing a particle size of the crystalline solids to yield reduced size crystalline solids;
redispersing the reduced size crystalline solids in a portion the caustic leach recycle stream;
further reducing a particle size of the redispersed the reduced size crystalline solids to yield a reduced particle size slurry; and
returning the reduced particle size slurry to the crystallization apparatus to provide the crystallization seeds.

47. The method of any one of claims 42 to 46, further comprising:
recycling at least a portion of the caustic leach recycle stream to the caustic leaching process.

48. The method of claim 47, further comprising:
removing a portion of the caustic leach recycle stream, before returning the caustic leach recycle stream to the caustic leaching apparatus, as a slip stream, thereby reducing the introduction of impurities contained in the caustic leach recycle stream into the caustic leaching apparatus.

49. The method of claim 48, wherein the impurities comprise one or more of organic compounds and alcohols.

50. The method of claim 48 or 49, wherein the slip stream is formed by removing about 10% to about 50% of the caustic leach recycle stream, preferably about 15% to about 45%, more preferably about 20% to about 40%, still more preferably about 25% to about 35%, and most preferably about 30% of the caustic leach recycle stream

51. The method of claim 42, further comprising, prior to separating the crystalline solids from the caustic crystallization slurry:
separating oversized crystalline solids from the caustic crystallization slurry thereby yielding a screened caustic crystallization slurry comprising undersized crystalline solids; and
feeding the screened caustic crystallization slurry into the solid-liquid separation apparatus as the caustic crystallization slurry.

52. The method of claim 51, wherein separating the oversized crystalline solids from the caustic crystallization slurry comprises utilizing one or more of a counter current settling apparatus and a hydrocyclone separation.

53. The method of claim 51 or 52, further comprising returning at least a portion of the crystalline solids to the crystallization apparatus as crystallization seeds.

54. The method of claim 38, further comprising:
subjecting the filter cake to a second caustic leaching process to yield a secondary pregnant leach solution; and
secondary filtering the secondary pregnant leach solution to yield a refined filter cake that is rich in black mass and a secondary aluminum rich leach stream, the refined filter cake having a lower aluminum concentration than the filter cake.

55. The method of claim 54, further comprising:
subjecting the aluminum rich leach stream to a crystallization process to yield a caustic crystallization slurry comprising crystalline solids;
subjecting the caustic crystallization slurry to a solid-liquid separation process to separate out the crystalline solids, and thereby yield a caustic leach recycle stream; and
feeding the caustic leach recycle stream into the second caustic leaching apparatus.

56. The method of claim 54 or 55, further comprising returning at least a portion of the secondary aluminum rich leach stream to the caustic leaching apparatus.

57. The method of any one of claims 37 to 57, wherein the size-reduced battery materials comprise aluminum at a first aluminum concentration, copper at a first copper concentration, and black mass at a first black mass concentration, and wherein the upgraded shred product has a second copper concentration that is higher than the first copper concentration; and
the black mass material has a second black mass concentration that is higher than the first black mass concentration.

58. The method of claim 37, wherein the caustic leaching process utilizes a caustic leaching solution having a pH that is greater than 9.

59. The method of claim 58, wherein the caustic leaching solution has a pH that is greater than 10, more preferably greater than 11, still more preferably greater than 12, still more preferably greater than 13, and most preferably 14 or higher.

60. The method of claim 58, wherein the caustic leaching solution has a NaOH concentration of between about 1 to about 10 M, preferably from about 2 to about 8 M, more preferably from about 3 to about 7 M, still more preferably from about 4 to about 6 M, and most preferably about 5 M.

61. The method of claim 58, further comprising maintaining the caustic leaching solution at an operating pressure of 0.8 to 1.2 times atmospheric pressure, preferably 0.85 to 1.15 times atmospheric pressure, more preferably 0.9 to 1.1 times atmospheric pressure, still more preferably 0.95 to 1.05 times atmospheric pressure.

62. The method of claim 61, wherein the operating pressure is about atmospheric pressure.

63. The method of any one of claims 58 to 60, further comprising inhibiting boiling of the caustic leaching solution by maintaining the caustic leaching solution at a temperature that between 0.7 times its boiling point and its boiling point at the operating pressure, preferably between 0.8 and 0.99 times, more preferably between 0.85 and 0.97 times, still more preferably between 0.88 and 0.95 times, still more preferably between 0.90 and 0.93 times, and most preferably about 0.92 times its boiling point at the operating pressure.

64. The method of any one of claims 37 to 63, further comprising maintaining the caustic leaching solution at a temperature of about 75, 80, 85, 90, 95, 100 or 105° C.

65. The method of any one of claims 58 to 64, further comprising controlling a caustic concentration of the caustic leaching solution.

66. The method of any one of claims 37 to 65, wherein separating the upgraded shred product from the pregnant leach solution using the first solid liquid separation apparatus comprises using a screen or a sieve.

67. The method of claim 66, wherein the screen or the sieve has openings of about 500 μm in size.

68. The method of any one of claims 37 to 67, further comprising rinsing the upgraded shred product with a washing liquid to recover residual caustic leaching solution from the upgraded shred products.

69. The method of any one of claim 38, wherein further comprises rinsing the filter cake with a washing liquid to recover residual caustic leaching solution from the filter cake.

70. The method of any one of claims 37 to 69, further comprising, prior to leaching the size-reduced battery materials, subjecting battery materials to a size reduction process under immersion conditions using a size reduction apparatus comprising an immersion comminuting apparatus having a housing containing an immersion liquid, at least one battery inlet through which the battery materials can be introduced into the housing, at least a first, submergible comminuting device disposed within the housing submerged in the immersion liquid and configured to cause a primary size reduction of the battery materials and release the copper, aluminum and black mass materials from within the battery materials to form reduced-size battery materials.

71. The method of any one of claims 37 to 70, further comprising, prior to the caustic leaching process, removing at least some ferromagnetic material from the size-reduced battery materials using a ferrous separator.

72. The method of claim 71, wherein the ferrous separator comprises a magnetic separator.

73. A system for processing size-reduced battery materials comprising aluminum, copper and black mass, the system comprising:
a caustic leaching apparatus configured to leach the shredded battery materials using a caustic leach solution; and
downstream from the caustic leaching apparatus:
a first solid liquid separation apparatus configured to separate a shred product comprising at least the copper from the size-reduced battery materials by mechanical separation;
a second solid liquid separation apparatus configured to separate a target shred material comprising at least the black mass material from the size-reduced battery materials; and
an aluminum separation apparatus configured to separate a solid comprising aluminum from the size-reduced battery materials.

74. The system of claim 73, further comprising:
upstream from the caustic leaching apparatus, a ferrous separator apparatus configured to separate a ferromagnetic product from a mixture comprising the shredded battery materials.

75. The system of claim 73 or 74, wherein the caustic leach solution is an aqueous solution comprising one or more of sodium hydroxide and potassium hydroxide.

76. The system of any one of claims 73 to 75, wherein the caustic leach solution has a pH of 13 or higher.

77. The system of any one of claims 73 to 75, wherein the caustic leach solution has a molarity of between about 1 and about 7 M.

78. The system of any one of claims 73 to 77, wherein the caustic leach solution is held at a temperature of about 100° C.

79. The system of any one of claims 73 to 78, wherein the caustic leach solution is at atmospheric pressure.

80. The system of any one of claims 73 to 79, wherein the caustic leaching apparatus is configured to output a pregnant leach stream, the pregnant leach stream comprising an aqueous aluminum-containing solution.

81. The system of any one of claims 73 to 80, further comprising a titration unit configured to control a concentration of the caustic leach solution within the caustic leaching apparatus.

82. The system of any one of claims 73 to 81, wherein the caustic leaching apparatus is configured to carry out a batch process and is configured to leach the shredded battery materials for a period of between 15 minutes and 12 hours.

83. The system of any one of claims 73 to 82, wherein the first solid liquid separation apparatus is immediately downstream from the caustic leaching apparatus.

84. The system of any one of claims 73 to 83, wherein the first solid liquid separation apparatus comprises a screen or sieve.

85. The system of claim 84, wherein the screen or sieve has openings of about 500 μm in size.

86. The system of claim 84 or 85, wherein the first solid liquid separation apparatus comprises a washing apparatus configured to rinse the shred product with water, for recovery of residual caustic leach solution from the shred product.

87. The system of any one of claims 73 to 86, wherein the shred product has a higher copper content than each of the target shred material and the solid comprising aluminum.

88. The system of any one of claims 73 to 87, wherein the second solid liquid separation apparatus is downstream from the first solid liquid separation apparatus.

89. The system of any one of claims 73 to 88, wherein the second solid liquid separation apparatus comprises a filter press having a filter with openings of about 200 μm in size.

90. The system of any one of claims 73 to 89, wherein the second solid liquid separation apparatus is configured to separate out the target shred material in form of a filter cake.

91. The system of claim 90, further comprising an additional washing apparatus configured to rinse the filter cake with a wash liquid, for recovery of residual caustic leach solution from the filter cake.

92. The system of any one of claims 73 to 91, the aluminum separation apparatus comprises a crystallization apparatus that is downstream from the second solid liquid separation apparatus.

93. The system of any one of claims 73 to 91, wherein the aluminum separation apparatus comprises a crystallization apparatus that is configured to receive an aluminum rich leach stream output from the second solid liquid separation apparatus, to cool the aluminum rich leach stream during a crystallization period, and to nucleate crystals of the solid comprising aluminum during the crystallization period.

94. The system of claim 93, wherein the crystallization apparatus is configured to run a batch process, and the crystallization period is between about 6 hours and about 72 hours.

95. The system of claim 93 or 94, wherein the crystallization apparatus is configured to run a continuous process.

96. The system of any one of claims 93 to 95, wherein the solid comprising aluminum comprises one or more of aluminum hydroxide and aluminum trihydroxide.

97. The system of claim 92, further comprising:
downstream from the crystallization apparatus, a crystal size classification apparatus configured to separate crystals of the solid comprising aluminum from liquor output from the crystallization apparatus, according to size of the crystals.

98. The system of claim 97, wherein the crystal size classification apparatus comprises one or more of a counter current settling apparatus and a hydrocyclone apparatus.

99. The system of claim 92, further comprising:
downstream from the crystallization apparatus, an oven configured to dry crystals of the solid comprising aluminum into a dried crystalline solid comprising aluminum.

100. The system of claim 99, further comprising:
downstream from the oven, a kiln or a furnace configured to calcine the dried crystalline solid comprising aluminum into an aluminum oxide product.

101. The system of claim 100, further comprising:
downstream from the crystallization apparatus, a solid-liquid separation apparatus configured to separate aluminum hydroxide solids from liquid by filtering.

102. The system of claim 101, wherein the aluminum-containing solids are sized to serve as seeds for nucleating crystals of the solid comprising aluminum, when the aluminum hydroxide solids are added into the crystallization apparatus.

103. The system of claim 101, wherein a filtrate from the aluminum solid filter press is configured to be returned to the caustic leaching apparatus as a caustic leach recycle stream.

104. The system of claim 103, further comprising a slip stream comprising a portion of the caustic leach recycle stream prior to being returned to the caustic leaching apparatus, for reducing accumulation of impurities in the system.

105. The system of claim 104, wherein the impurities comprise one or more of organic compounds and alcohols.

106. The system of claim 101, further comprising a second caustic leaching apparatus configured to leach the separated target shred material using a second caustic leach solution.

107. The system of claim 106, wherein a filtrate of the aluminum solid filter press is configured to be fed into the second caustic leaching apparatus as at least a portion of the second caustic leach solution.

108. A method of processing shredded battery materials to extract a target shred material, the method comprising:
subjecting the shredded battery materials to a caustic leaching process to yield a pregnant leach solution;
screening the pregnant leach solution to separate out large solids, and to provide a screened leach stream;
filtering the screened leach stream to yield a filter cake comprising the target shred material, and an aluminum rich leach stream;
subjecting the aluminum rich leach stream to a crystallization process to yield a caustic crystallization slurry comprising solid crystals; and
filtering the caustic crystallization slurry to separate out solids, and thereby yield a caustic leach recycle stream.

109. The method of claim 108, further comprising:
returning the solids to the crystallization process as seeds.

110. The method of claim 108, further comprising:
returning the caustic leach recycle stream to the caustic leaching process.

111. The method of claim 108, further comprising, prior to filtering the caustic crystallization slurry:
subjecting the caustic crystallization slurry to a crystal size classification process to separate out oversized solids, and thereby yield a screened caustic crystallization slurry comprising undersized solids; and
filtering the screened caustic crystallization slurry to separate out the undersized solids, and thereby yield the caustic leach recycle stream.

112. The method of claim 111, further comprising:
returning the undersized solids to the crystallization process as seeds.

113. The method of claim 111, further comprising:
subjecting the separated oversized solids to at least one of a drying process and a calcining process.

114. The method of claim 108, further comprising:
subjecting the filter cake comprising the target shred material to a second caustic leaching process to yield a secondary pregnant leach solution; and
filtering the secondary pregnant leach solution to yield a refined filter cake comprising the target shred material, and a secondary filtered leach stream.

115. The method of claim 114, further comprising:
feeding the caustic leach recycle stream to the second caustic leaching process.

116. The method of claim 114, further comprising:
returning the secondary filtered leach stream to the caustic leaching process.

117. The method of claim 108, further comprising:
carrying out the caustic leaching process at a temperature of about 100° C.

118. The method of claim 108, further comprising:
carrying out the caustic leaching process at atmospheric pressure.
